(19) United States
(12) Patent Application Publication
(10) Pub. No.: US 2026/0284578 A1
(43) Pub. Date: Sep. 24, 2026

(54) METHOD FOR PRODUCING A DEACIDIFIED FLUID STREAM AND AN APPARATUS FOR DEACIDIFYING A FLUID STREAM

(71) Applicant: BASF SE, Ludwigshafen am Rhein (DE)

(72) Inventors: Johannes Felix HAUS, Ludwigshafen am Rhein (DE); Alexander SCHROEDER, Ludwigshafen am Rhein (DE); Lukas MAYR, Ludwigshafen am Rhein (DE); Georg SIEDER, Ludwigshafen am Rhein (DE); Martin RHEINFURTH, Ludwigshafen am Rhein (DE); Iven CLAUSEN, Ludwigshafen am Rhein (DE)

(21) Appl. No.: 19/484,411

(22) PCT Filed: May 7, 2024
(86) PCT No.: PCT/EP2024/062542

§ 371 Date: Nov. 14, 2025

(30) Foreign Application Priority Data
May 16, 2023 (EP) 23173606.7
May 16, 2023 (EP) 23173607.5
May 16, 2023 (EP) 23173608.3
May 16, 2023 (EP) 23173610.9

(51) Int. Cl. B01D 53/14; B01D 53/18

(52) U.S. Cl. CPC B01D 53/1425; B01D 53/18; B01D 2258/0283; B01D 2259/65

(57) ABSTRACT

This invention relates to a method for producing a deacidified fluid stream comprising a direct contact cooler and one or more heat pumps. The invention further relates to an apparatus for deacidifying a fluid stream comprising a direct contact cooler and one or more heat pumps.

This invention relates to a method for producing a deacidified fluid stream comprising the combination of a heat pump and a direct contact cooler (DCC) to transfer energy from a heat source to the regeneration step.

In a second aspect, the invention relates to an apparatus for producing a deacidified fluid stream comprising a heat pump and a direct contact cooler (DCC).

In view of increased indicators for an imminent climate change and its drastic impacts on the world population, the United Nations Sustainable Development Goals have identified the necessity to take “Climate Action” as one of 17 sustainable development goals.

One of the 17 goals is no integrate climate change measures into national policies, strategies and planning. The European Union has imposed a set of climate change policy initiatives with the goal of making the European Union climate neutral in 2050. With a more immediate effect, the greenhouse gas emission reduction targets are increased to about 50% compared to the 1990 levels and the achievement of net-zero greenhouse gas emissions is aimed to be achieved by 2050. Similar initiatives and incentives for climate protection measures have been taken by other governments worldwide.

Carbon dioxide is one of the most abundant greenhouses gases in the atmosphere.

Greenhouse gases are such gases that absorb and emit infrared radiation in the wavelength range emitted by the earth and thus contributing to global warming. CO₂ levels in the atmosphere have increased from approx. 280 ppm in preindustrial times at around the year 1750 to about 421 ppm in the year 2022. Approximately two thirds of all carbon dioxide emissions result from the combustion of fossil fuels.

Most climate action measures require huge financial investments and have an implementation time of several years and decades.

Carbon capture and storage (CCS) or carbon capture utilization and storage (CCUS) are readily available and developed technologies which can be implemented on a large scale and on a shorter timescale and can therefore have a more immediate impact on climate change. Carbon dioxide may be captured directly from industrial sources, such as cement production, natural gas processing and ammonia and hydrogen production, or from fossil or biomass fuel powered power plants. A carbon capture rate from flue gas from carbon-based fuels of 80 to 95% is currently feasible.

Captured carbon dioxide can be removed from the atmosphere by carbon sequestration or carbon storage in suited geological formations, such as depleted oil and gas reservoirs, mines and saline or other rock formations. Prior to transporting carbon dioxide to its final storage place and injection to the underground, it is usually compressed to high pressures of around 100 bar. Other utilizations of captured carbon dioxide are enhanced oil recovery or conversion to fuel, cement, minerals, or chemicals.

Currently, amine gas treating is one of most mature methods for carbon capture. Amine gas treating refers to processes in which acidic gases (sour gas), such as carbon dioxide or hydrogen sulfide are removed from a feed gas stream by absorption in amine solvents. A typical acid gas removal unit (AGRU) comprises an absorber and a regenerator as well an ancillary equipment. In the absorber, the downflowing amine absorbs the acidic components of the feed gas to obtain a sweetened gas or sweet gas stream and an amine solution partially laden with the acidic components (“rich amine”). The rich amine solution is then fed to a regenerator or stripper where it is heated to strip or flash the desorbed acid gas overhead and to produce a regenerated amine solutions (“lean amine”) which can be recycled to the absorber. Stripped CO₂ is then compressed, dried, and optionally refrigerated and transported to its storage destination.

Amine gas treating is a relatively energy intensive process. It has been estimated that up to 40 percent of the energy produced by a power station is consumed by carbon capture and sequestration. This energy penalty splits into a value of around 60% for the amine gas treating process and 30% for carbon dioxide compression. The energy extensive part of amine gas treating is the stripping of captured carbon dioxide in the stripper. Temperatures in the absorber are usually around 30 to 70° C., whereas the temperatures necessary to strip carbon dioxide are usually in the range of 100 to 150° C. The energy required for heating the rich amine is usually supplied by transferring heat from hot process steam to the rich amine in the regenerator.

Process steam maybe produced in combined cycle gas power plants. In such cases, steam production from power production may be integrated into the amine gas treating process. However, a steam integration with existing steam sources is not always possible for all AGRUs and the required steam then needs to be provided by a stand-alone process steam production process, such as a steam boiler.

Accordingly, numerous activities address the need to reduce the energy consumption of amine gas treating units.

One possible strategy to reduce the energy consumption is by trying to improve the cyclic capacity of the amine solvent and reduce the energy required to regenerate the amine solvent. Solvent development is however quite cost and time extensive and often requires the use of specialized, high priced solvent systems leading to higher operational costs.

Another strategy employed to reduce the energy consumption of amine gas treating units is to transfer heat from sources within the gas treating unit having a higher temperature to places having a lower temperature.

The most prominent example for such a heat-transfer measure is the so-called crossflow heat exchanger between the regenerator and the absorber in which the hot lean amine exiting the regenerator is heating up the cold rich amine from the absorber before the rich amine is fed to the regenerator. However, indirect heat exchange by crossflow heat exchangers is usually not sufficient to supply the bulk of the energy required to operate the stripper.

U.S. Pat. No. 3,823,222 teaches the utilization of the energy contained in hot feed gases which are to be deacidified in an AGRU to produce steam in separate boilers which can be used for steam stripping in the regenerator to heat the reboiler of the regenerator.

U.S. Pat. No. 3,101,996 also teaches the utilization of hot fluid streams, such as synthesis gas or hydrogen gas obtained in a water shift reaction, to produce steam in separates boilers which can be used to heat the amine stripper.

WO200712143 discloses two separate cooling stages for cooling hot flue gas from a steam turbine before amine gas treating. In an initial stage, the flue gas is cooled in a heat exchanger by indirect heat exchange with a fluid that is used to heat the stripper. In a second stage, the flue gas is cooled by transferring thermal energy to a heat pump system used to heat the stripper. The heat pump system can be supplemented by heat regenerated in other heat sources, such as the CO₂-compression stage.

The use of heat pumps to transfer energy from process units of a higher thermal energy level to process units having a lower thermal energy level is not only limited to the hot feed gases. Almost every heat source in an amine gas treating process has been suggested for utilization with a heat pump.

WO2010097047 and WO2011122525 utilize the heat of absorption in the absorber as a heat source for heat pumps to heat the rich amine solution.

JP2015131735 uses an intercooler loop in the absorber as a heat source for a heat pump to heat the stripper.

WO200781214 and CN114405258 discloses the use of the condensation energy generated in the condenser of a stripper as a heat source.

WO201258558 describes the use of the thermal energy of the stripper gas in the overhead condenser as heat source for a heat pump. The disclosure is limited to the removal of SO₂ from gaseous mixtures, but the principle can theoretically be transferred to CO₂-removal.

JP2010088982 discloses the use of the heat of compression generated in the compressor(s) used to compress the carbon dioxide to high pressures to heat the rich amine solution.

JP2015131736 essentially teaches the replacement of the conventional crossflow heat exchanger used to transfer heat from the hot lean amine solution exiting the stripper to the rich amine solution entering the stripper with a heat pump.

FR2968574 discloses the use of multiple heat sources for heat pumps, such as the overhead condenser of the stripper, the lean amine solution exiting the absorber and the overhead condenser of the absorber used to remove water vapor from the sweetened gas.

Likewise, CN10289584 mentions the use of the lean amine solution exiting the regenerator stripper and the stripper overhead condenser as a heat source for heat pumps. It is also possible to use heat sources outside the amine gas treating process. CN112126477 discloses the use of blast furnace slag rinsing water as a heat source for heating the stripper with a heat pump.

The energy comprised in the disclosed various heat sources is usually not high enough to provide the full energy required in the stripping step. Therefore, multiple heat sources need to be tapped requiring the use of more than one heat pump. The use of several heat pumps increases the capital costs of an amine gas treating unit.

Despite the great number of disclosures focused on heat integration in gas treating, there is still a need for a heat integration solution which can supply most, or all of the energy required in the regenerator and does not result in a drastic increase of capital costs.

Thus, the problem underlying the present invention was to provide a way for reducing the energy demand of a gas treating unit using a liquid absorbent while reasonably limiting additional investments into the plant infrastructure. A further problem underlying the present invention was to reduce corrosion and fouling in equipment being in contact with the fluid stream. Another problem underlying the present invention was to avoid the need for costly equipment required to transport gaseous streams. In addition, it was an object of the present invention to electrify steam production required for the regeneration of a rich absorbent solution and to potentially detach steam production from power production in the power plant or the need to provide stand-alone steam producing facilities. A further object of the present invention was to reduce the energy demand for steam production required in the regeneration step. Still another object of the further invention was to provide a method for gas treatment which is flexible and can accommodate for fluctuations in the load of the feed gas stream supplied to a gas treatment unit. This problem has become of increased importance with the increased introduction of energy from renewable resources into the energy grid which is subject to fluctuations resulting from the amount of wind and solar power available. Such fluctuations in energy supply need to be balanced by either carbon fuel-based power plants which are turned up to compensate for energy shortfalls and therefore themselves produce a varying stream of flue gas which needs to be handled by the acid gas removal process.

1st aspect-Method for Producing a Deacidified Fluid Stream by a Heat Transfer Process Comprising Two or More Heat Pumps

In a first aspect, the invention is directed to a method for producing a deacidified fluid stream comprising:
a) a thermal energy transfer step in which thermal energy is transferred from a fluid stream FS1 comprising at least one acid gas to the regeneration step c) to obtain a fluid stream FS2 having a reduced thermal energy compared to fluid stream FS1;
b) an absorption step in which the cooled fluid stream FS2 is contacted with an absorbent A1 in an absorber to obtain an absorbent A2 laden with acid gases and an at least partly deacidified fluid stream;
c) a regeneration step in which at least a portion of the laden absorbent A2 obtained from step b) is regenerated in a regenerator obtain an at least partly regenerated absorbent A3 and a gaseous stream GS comprising least one acid gas;
d) a recycling step in which at least a substream of the regenerated absorbent A3 from step c) is recycled into the absorption step b);
   wherein the thermal energy transfer step a) comprises the combination of a direct contact cooler DCC and one or more heat pumps.

### Thermal Energy Transfer Step a);

The method of the present invention comprises transferring thermal energy transfer step a) in which thermal energy is transferred from a fluid stream FS1 comprising at least one acid gas to the regeneration step c) to obtain a fluid stream FS2 having a reduced thermal energy compared to fluid stream FS1.

### Fluid Stream FS1

The fluid stream FS1 from which thermal energy is transferred to the regeneration step c) may be any fluid stream comprising at least one acid gas.

Preferably the preferably the fluid stream FS1 comprises CO₂. In addition to CO₂, other acid gases, such as H₂S, CS₂ or COS may be present. In addition, oxides of sulfur and nitrogen SOₓ and NOₓ may be present.

The content of acid gases in the fluid stream FS1 is generally 0.01% to 40% by volume, preferably 2% to 30% by volume and more preferably 3% to 25% by volume.

The fluid stream FS1 introduced into the process of the invention may comprise water.

The water content in the fluid stream is generally within a range from >0% by volume up to a content corresponding to the saturation concentration of water in the fluid stream under the existing pressure and temperature conditions.

The pressure of fluid stream FS1 usually depends on the source of the fluid stream FS1 as further outline below.

Preferably, the fluid stream FS 1 is a flue gas.

Flue gases are preferably obtained by combustion of carbon-based fuels, such as fossil fuels like coal, natural gas and oil, or biomass feedstocks from plants, algae or animals. Such combustion processes can occur in power plants or power stations. Preferably, the source of the flue gas is from combustion of coal, natural gas, oil, biofuels, such as bioethanol or biodiesel, or biomass derived from forestry, agriculture or aquaculture. Preferably, fluid stream FS1 is a flue gas exiting the steam turbine of a steam-electric power stations in which the generator is driven by steam obtained from the combustion of carbon-based fuels.

Most preferably, fluid stream FS1 is a flue gas exiting the steam turbine of a gas-fired power plant which is designed as a simple cycle gas-turbine or a combined cycle power plant.

Prior to being used in the method of the present invention, the flue gas stream FS1 is optionally treated to remove particulate matter by filtration or electrostatic precipitation. In a preferred embodiment, the flue gas stream FS1 is desulfurized by removing sulfur dioxide. An overview of flue-gas desulfurization methods can be found in the Wikipedia article “Flue-gas desulfurization” (https://en.wikipedia.org/wiki/Flue-gas desulfurization). Fluid flue gas stream FS1 preferably comprises:
CO₂: 1 to 25 vol. %, preferably 5 to 20 vol.-%;
H₂O: 3 to 50 vol. %, preferably 5 to 30 vol.-%; and
O₂: 0.1 to 16 vol. %, preferably 1 to 10 vol.-%,
Additionally, flue gases comprise small amounts of other gases, in particularly nitrogen oxides (NOₓ) and sulfur oxides (SOₓ), even after a flue gas desulfurization step. Flue gas also comprises nitrogen in an amount so that sum of the volume fractions of each component present in the flue gas add up to a value of 1 (or 100 vol.-%). Typically, the nitrogen content is in the range of 40 to 95 vol. %.

Fluid stream FS1 is preferably in the gaseous state. Depending on the temperature and the water content, fluid stream FS1 may also comprise condensed water and acids. When the fluid stream is a flue gas, the pressure of the fluid stream FS1 entering the cooling step is usually at atmospheric pressure, preferably in the range of 0.7 to 1.5 bar, more preferably 0.8 to 1.3 bar and more preferably 0.9 to 1.2 bar.

The temperature of fluid flue gas stream FS 1 is preferably in the range of 50 to 300° C., preferably 60 to 250° C. and most preferably 60 to 200° C.

Fluid stream FS1 may also be an off-gas stream in which CO₂ is emitted in an industrial process which liberates CO₂ from a chemical reaction. Such industrial process streams include CO₂-emissions from the thermal decomposition of limestone and dolomite in the production of cement, CO₂-emissions from using carbon as a reducing agent in the commercial production of metals from ores (e.g. the production of iron in a blast furnace), or CO₂-emissions from the fermentation of biomass (e.g. to convert sugar to alcohol).

In a preferred embodiment, fluid stream FS1 is stream which combines flue gas from a carbon-fuel combustion process with CO₂-emissions from a CO₂-producing industrial process, such as cement production, metal production or fermentation processes. In a further preferred embodiment, fluid stream FS1 is a flue gas stream coming from a furnace of a cracker, in which hydrocarbons, such as petroleum fractions, naphtha, natural gas liquids, such methane, ethane and propane, are thermically or catalytically cracked to obtain shorter chain molecules or recombined molecules having a different structure. Preferably, the fluid stream FS1 is the flue gas of a steam cracker furnace.

The fluid stream FS1 may alternative be a crude synthesis gas. Such a synthesis gas (or “syngas”) may be obtained from the gasification of coal or mineral oil, steam reforming of mineral oil distillates, the steam reforming of methane, or auto thermal reforming of natural gas. Syngas usually comprises at least hydrogen, carbon monoxide and some carbon dioxide and water.

A preferred fluid stream FS1 is the fluid stream exiting the water shift reactor in the production of synthesis gas. The water shift reaction is preferably carried out as a high temperature shift conversion (HTSC) at temperature of about 300 to 450° C., a medium temperature shift conversion (MTSC) at temperatures of about 150 to 350° C., a low temperature shift conversion (LTSC) at temperatures of about 150 to 250° C. or a sour gas shift conversion (SGS) at temperatures of about 200 to 300° C.

When the fluid stream is a synthesis gas, the total pressure is usually in the range of 5 to 120 bar, preferably 10 to 100 bar and more preferably 10 to 60 bar.

According to the present invention, the thermal energy transfer step comprises the combination of a direct contact cooler DCC with a heat pump HP1.

### Direct Contact Cooler (DCC)

In step a), thermal energy from fluid stream FS1 is transferred to the regeneration step c) in a configuration comprising a direct contact cooler.

The term “direct contact” in direct contact cooler means that the stream FS1 and the stream acting as a cooling medium stream or heat transfer material stream are not spatially separated by a partitioning but are in direct physical contact with each other (direct heat exchange).

Direct heat exchange has the advantage that the exchange area between the two fluids increases, which reduces thermal resistances and maximizes the thermal efficiency. In addition, direct heat exchangers usually have lower operating and capital costs than indirect heat exchangers due to a high heat transfer rate per volume and because fouling and corrosion is usually not a problem. Corrosion is a non-negligible problem in indirect heat exchangers in case of residual sulfur oxides (SOₓ) in the fluid stream FS1 which can cause dew point corrosion if the temperature of any metal in contact with FS1 is below the dew point of sulfuric acid, which typically is in the range of 110 to 170° C. Further, the pressure loss in a direct contact cooler is lower compared to an indirect gas-to-liquid heat exchanger. Therefore, the size of costly equipment, such as fans or blowers, required to compensate the pressure loss and to transport fluid stream FS2 to the absorber can be reduced or even avoided.

Direct contact preferably occurs in a direct contact cooler (DCC) in which heat is transferred from fluid stream FS1 to the liquid cooling medium stream CMS1 to obtain a cooling medium stream CMS2 having a higher thermal energy than cooling medium stream CMS2 and a cooled fluid stream FS2. Within the present invention, the terms “direct contact condenser” and “direct contact cooler” are used synonymously, because the degree of condensation which occurs in the DCC depends on the water content of the feed gas.

Direct contact cooling can be accomplished with the following devices: a) spray columns, b) baffle tray columns, c) sieve tray or bubble tray columns, d) packed columns, e) pipeline contactors, and f) mechanically agitated contactors.

Further details relating to the design of direct contact coolers can be found in the review article by Madejski et al. (Madejski, P.; Kus, T.; Michalak, P.; Karch, M.; Subramanian, N. Direct Contact Condensers: A Comprehensive Review of Experimental and Numerical Investigations on Direct-Contact Condensation. Energies 2022, 15, 9312. https://doi.org/10.3390/en15249312) and in Kreith, Frank & Boehm, Robert. (1987). Direct-Contact Heat Transfer. 10.1615/AtoZ.d.DIRCONHEATRA, Chapter 19, pages 1359 to 1399.

Preferably, direct contact coolers are operated in a counter flow mode, meaning that the heat stream FS1 typically enters at an inlet opposite the inlet for the cooling medium stream CMS1 or heat transfer material stream HTMS1. However, it is also possible to operate the direct contact cooler in a parallel flow mode, where CMS1 or HTMS1 and FS1 enter the heat exchanger from the same direction. A parallel flow mode direct contact cooler is described in U.S. Pat. No. 9,034,081.

Most preferred direct contact coolers are spray columns, baffle tray columns, sieve tray or bubble tray columns and packed columns. More preferably, the coolers are operated in a counter current flow mode.

In the direct contact cooler, heat stream FS1 preferably comes into direct contact with cooling medium stream CMS1 or heat transfer material stream HTM1 and thermal energy is transferred from heat stream FS1 to obtain a cooled fluid stream FS2 and a heated cooling medium stream CMS2 or heated heat transfer material stream HTMS2 or HTMS2a (see below).

The cooling medium streams CMS1 and CMS2 are streams of a cooling medium CM. Cooling medium CM is preferably one or more cooling media selected from the group consisting of ethylene glycol, 1,2-propylene glycol, 1,3-propyleneglycol and their corresponding polyglycols, such as diethylene glycol, triethylene glycol, 1,2-dipropylene glycol, 1, 2 tripropylene glycol, 1,3-dipropylene glycol and 1, 3 tripropylene glycol, their corresponding methyl or dimethyl ether and water. Preferably, the cooling medium CM is ethylene glycol or water, or mixtures of ethylene glycol and water Most preferably the cooling medium CM essentially consists of water. The use of pure water has the advantage that an additional separation step is not needed. An additional separation step is preferred when the cooling medium stream CMS1 comprises other components than water because the water which is comprised in the heat stream FS1 leads to a dilution of the concentration of the other, non-aqueous components. To restore the original concentration, an additional separation step is preferred to separate the water introduced into cooling medium streams CMS1 or CMS2 with heat stream FS1.

The direct contact cooler is preferably designed in a manner so that following requirement are fulfilled:
the temperature T_{CMS1} is in the range of 25 to 100, preferably 25 to 70 and more preferably 30 to 50° C.
the temperature T_{CMS2} is approximately 5 to 100 K preferably 10 to 80 K and more preferably 15 to 50 K higher than T_{CMS1}.
the temperature T_{FS2} is preferably in the range of 20 to 80° C., more preferably 25 to 70° C. and most preferably in the range of 30 to 60° C.

The direct contact cooler is usually also operated so that cooling medium stream CMS2 remains in a liquid state so that it can therefore be readily separated from gaseous fluid stream FS2.

A part of the cooling medium stream CMS2 may be purged from the cooling medium stream cycle if additional moisture comprised in fluid stream FS1. The amount of cooling medium stream purged is selected in a manner that the cooling medium flow rate remains essentially constant.

In a preferred embodiment, the direct contact cooler is designed in a manner that more energy is transferred than is needed to provide to the regeneration step. In this case, the excess energy can be preferably used to provide excess steam which can be transferred to an onsite steam network to be distributed to other processes or process steps on site, which may require such energy.

Alternative, it is also possible to design the direct contact cooler in a manner that less energy is transferred than is needed in the regeneration step. In this case, it is preferably to provide additional energy, preferably steam, to the regeneration step from other sources, e.g an onsite steam network which distributes steam from other steam producing sources.

The direct contact cooler is preferably designed in a manner that the transferred thermal energy is just sufficient to provide the thermal energy required in the regeneration step c). If more thermal energy or heat is comprised in heat stream FS1 than is necessary to be transported by the heat pumps to the regeneration step c), than only the energy required in the regeneration step c) is transferred in the direct contact cooler. If after transfer of the heat or thermal energy required for the regeneration step c), fluid stream FS2 would be too hot to enter the absorber, it is preferable that the fluid stream FS2 exiting the direct contact cooler is cooled in one or more additional heat exchangers prior to entering the absorber, so that fluid stream FS2 has a temperature in the range of 20 to 80° C., more preferably 25 to 70° C. and most preferably 30 to 60° C. at the inlet of the absorber. Such additional heat exchanger are air coolers or water coolers, such as cooling towers. An overview over cooling towers which can be used to further cool fluid stream FS2 can be found in the Wikipedia article “Cooling towers” (https://en.wikipedia.org/wiki/Cooling tower #). This embodiment has the advantage that the temperature of fluid stream FS2 at the absorber inlet can be independently adjusted from the operation of the heat pump HP1, as described below.

### Heat Pump

According to the present invention, the transfer of thermal energy from heat stream FS1 to the regeneration step c)) also comprises one or more heat pumps.

Within the meaning of the present invention, a heat pump is a device for transferring heat from a heat source at one temperature to a heat sink at a higher temperature. The heat pump may be a conventional heat pump employed in a process according to embodiment A, described below, or two or more conventional heat pumps which are connected in series, and which may be operated according to embodiment B described below. The heat pump may also be a so-called modified heat pump operated according to a process described in embodiment C below. The so-called modified heat pump differs from a conventional heat pump in that the evaporator of the heat pump is replaced by a heat exchanger in which the working medium does not undergo a phase transition, followed by a separate evaporation means for evaporating the heat transfer material. In other words, heat transfer and evaporation, which are affected in the evaporator of a conventional heat pump, are carried out in two distinct process steps as described in embodiment C below.

### Conventional Heat Pump

A conventional heat pump preferably comprises:
a heat exchanger HE1 for the transfer of thermal energy from cooling medium stream CMS2 to the heat transfer medium stream HTMS1 of heat pump HP1 to obtain a heat transfer material stream HTMS2 having an increased thermal energy compared to heat transfer medium stream HTMS1,
one or more compressors for compressing heat transfer material stream HTMS2 in one or more compression steps to obtain a heat transfer material stream HTMS3 having an increased pressure compared to heat transfer material stream HTMS2,
a heat exchanger HE-R for the transfer of thermal energy from heat transfer material stream HTMS3 to the regeneration step,
a heat transfer material HTM1.

The heat transfer step a) comprising the combination of a direct contact cooler and a conventional heat pump is further described in embodiment A, below.

### Serially Connected Heat Pumps

A serially connected heat pump means that the compressed heat transfer medium of heat pump HP1 serves as a heat source for the heat medium transfer stream of heat pump HP2, which acts as the heat sink for heat pump HP1 and that thermal energy from heat transfer medium stream HTMS of heat pump HP1 to the heat transfer medium stream of heat pump HP2 is being affected through a common heat exchanger HE2. In other words, the heat exchanger HE2 functions as a condenser for the heat transfer material HTM1 of heat pump HP1 as well as an evaporator for the heat transfer material HTM2 of heat pump HP2. Accordingly, a serially connected heat pump comprises a heat exchanger HE1 for the transfer of thermal energy from cooling medium stream CMS2 to the heat transfer medium stream HTMS1 of heat pump HP1 to obtain a heat transfer material stream HTMS2 having an increased thermal energy compared to heat transfer medium stream HTMS1,
one or more compressors for compressing heat transfer material stream HTMS2 in one or more compression steps to obtain a heat transfer material stream HTMS3 having an increased pressure compared to heat transfer material stream HTMS2, a heat exchanger HE2 for the transfer of thermal energy from heat transfer material stream HTMS3 to a second heat transfer medium stream SHTMS1 of heat pump HP2 to obtain a second heat transfer material stream SHTMS2 having an increased thermal energy compared to heat transfer medium stream SHTMS1,
one or more compressors for compressing the second heat transfer material stream SHTMS2 in one or more compression steps to obtain a heat transfer material stream SHTMS3 having an increased pressure compared to heat transfer material stream SHTMS2,
a heat exchanger HE-R for the transfer of thermal energy from heat transfer material stream HTMS3 of the first heat pump HP1 to the regeneration step,
a heat transfer material HTM1 and a heat transfer material HTM2.

The use of two heat pumps which are connected in series has the advantage that the thermal energy from the heat stream HS1 can be raised to a level at where it is possible to effectively generate steam in heat pump HP2 which can be used to transfer heat to the regeneration step c). The stream produced in heat pump HP2 can therefore effectively replace process steam usually required as a heat source in the regeneration step c). Accordingly, the use of two heat pumps in series can replace the requirement to have a separate process steam production process installed at the site of the acid gas removal unit or the requirement for steam turbines, such as back pressure turbines or pass-out condensing turbines, to produce process steam at the electric power plant which is to be decarbonized. The present invention is therefore particularly useful where process steam is not readily available at the site of an acid gas removal unit. But also, at sites where process is steam is readily available, the method according to the present invention may be useful as an alternative method to produce process steam as it allows to use potentially limited process steam resources for other uses or allows to reduce power loss of power plants associated with process steam production. In addition, the method of the present invention is an interesting alternative in the design of new power plants coupled to an acid gas removal unit for carbon capture because the requirement to divert energy for steam production to power the recycling step can be reduced. In addition, the method of the present invention is a useful method to electrify steam production so that the steam required in the amine gas treating process can be provided by “green” electricity from renewable resources.

The heat transfer step a) comprising the combination of a direct contact cooler and a serially connected heat pump is further described in embodiment B, below.

### Modified Heat Pump

The heat pump of the present invention may also be designed as a modified heat pump. In a modified heat pump, heat exchanger HE1 is not an evaporator but a heat exchanger in which a phase transfer from the liquid the liquid heat transfer material stream HTMS1 to the gaseous heat transfer material stream HTMS2 does substantially not occur but which is rather configured to obtain a liquid heat transfer material stream HTMS2a and the phase transition from liquid heat transfer material stream HTMS2a to obtain a gaseous heat transfer material stream HTMS2b proceeds by feeding heat transfer material stream HTMS2a to a means for evaporation. The means for evaporation is usually a combination of an expansion valve and an expansion vessel. Expansion is preferably carried out as a flash evaporation of heat transfer material stream HTMS2a through an expansion or throttling valve into a vessel having a lower pressure than ρ_{HTMS2a}. Accordingly, in a modified heat pump the steps of heat transfer and evaporation are carried out as separate process steps. Accordingly, the modified heat pump comprises a heat exchanger HE1 and additionally a means for expansion or evaporation of a liquid heat transfer material stream HTMS2a.

The use of a modified heat pump in which the heat transfer step and the evaporation step are two distinct steps also has the advantage that the thermal energy from heat stream HS1, in particularly FS1, can be raised to a level at where it is possible to generate steam in the heat pump HP1 which can be used to transfer heat to the regeneration step c). The embodiment has similar advantages than serially connected heat pumps.

The heat transfer step a) comprising the combination of a direct contact cooler and a modified heat pump is further described in embodiment C, below.

### Heat Transfer Material

A heat pump usually comprises a heat transfer material.

Heat transfer material HTM1 is the working fluid used in heat pump HP1.

Heat transfer material HTM2 is the working fluid used in a second serial heat pump HP2.

Further heat transfer materials HTM3 to x can be used in heat pumps HP3 to HPx if more than two heat pumps are connected.

The heat transfer material HTM1 is a working fluid used in heat pump HP1 to transport thermal energy from heat exchanger HE1 to heat exchanger HE2 or HE-R, depending on the embodiment and design of the heat pump HP1.

Preferably, the heat transfer material HTM1 can undergo at least a partial phase transition from the liquid to the gas state upon transfer of thermal energy in heat exchanger HE1 (in case of a conventional heat pump) or in heat exchanger HE1 and the subsequent expansion step (in case of a modified heat pump).

Preferably, the heat transfer material HTM1 can also undergo at least a partial phase transition from the gas to the liquid state upon transfer of thermal energy in heat exchanger HE2 (in case of a serially connected heat pump) or heat exchanger HE-R (in case of a single conventional heat pump or a single modified heat pump). Heat transfer material HTM1 is therefore preferably selected from the group of refrigerants consisting of ammonia, butane, R1233zd(e), R1224yd(z), air, CO₂, water, chlorofluorocarbon, hydrochlorofluorocarbon, hydrofluorocarbon, hydrofluoroolefin, hydrochlorofluoroolefin, hydrocarbon, perfluoro (2-methyl-3-pentanone) and mixtures of two or more thereof. Suitable refrigerants are known to the skilled person and are disclosed, for example, in C. Arpagaus et al. (C. Arpagaus et al., Energy 152 (2018), pages 985 to 1010).

The case of a single conventional heat pump or a single modified heat pump, the heat transfer material HTM1 is most preferably water. If heat transfer material HTM1 is water, the heat transfer material HTM1 can be directly used for steam production required in the regeneration step c), in particularly the reboiler HE-R or in other plants of a Verbund-site. In addition, water is an environmentally friendly heat transfer material which can be disseminated to the environment either directly or after being submitted to a wastewater purification plant. Water is also readily available in many plants or facilities and can be provided in the required amounts even without the necessity of recycling the water. Water has the further advantage that steam can be potentially supplemented from other sources should the regeneration step require more steam than which is produced using the heat pumps or it can be distributed to other consumers, e.g., an onsite steam network, in case an excess amount of steam is produced. This makes the process of the present invention very flexible.

Likewise, the second heat transfer material HTM2 of heat pump HP of two serially connected heat pumps HP1 and HP2 is also most preferably water. This selection of water as preferred heat transfer material applies generally to the last heat pump of a series of connected heat pumps.

In case of two serially connected heat pumps, HTM1 of heat pump HP1 is usually a heat transfer material having a lower boiling point than water at the condition of the condenser of heat pump HP and is most preferably ammonia, butane, R1233zd(e), R1224yd(z), air, CO₂, water, chlorofluorocarbon, hydrochlorofluorocarbon, hydrofluorocarbon, hydrofluoroolefin, hydrochlorofluoroolefin, hydrocarbon, perfluoro (2-methyl-3-pentanone) and mixtures of two or more thereof. Using a heat transfer material HTM1 having a lower point in the first heat pump HP1 allows for a higher heat flow from fluid stream FS1, especially if the temperature of fluid stream FS1 or cooling material CMS2 is not sufficiently high to generate steam directly. In case of a serially connected heat pump, heat transfer material HTM1 of heat pump HP1 preferably ammonia or butane, most preferably ammonia.

### Open Loop and Closed-Loop Heat Pumps

The conventional or serially connected heat pumps—as described above—may be designed as an open-loop or closed loop heat pump.

An open-loop heat pump usually comprises the steps of:
transferring thermal energy from the heat source to a heat transfer material, usually by means of a heat exchanger, which usually is designed as an evaporator for at least a part of the heat transfer material of the heat pump.
compressing partially gasified heat transfer material in one or more compression steps, which usually include one or more compressors, to increase the temperature of the heat transfer material, and
transferring thermal energy from the compressed heat transfer material to the heat sink, usually by means of another heat exchanger functioning as a condenser for the at least partially gaseous heat transfer material of the heat pump.

An open loop heat pump has the advantage that can utilize media from a variety of sources, in particularly water which is usually already present in an amine gas treating process.

A closed-loop heat pump usually comprises a heat transfer medium between the heat source and the heat sink in a closed loop. This is usually implemented by additional recycling steps for the heat transfer medium, such as the recycling steps R1 or R2 for heat pumps HP1 or HP2 which are further described below.

The modified heat pump described above is preferably designed as an open-loop heat pump. An open loop heat pump has the advantage that can utilize media from a variety of sources, in particularly water which is usually already present in an amine gas treating process. In addition, an open-loop heat pump does not require the recycling of the heat transfer material which allows the simplification of the heat pump design and potentially allows to make it more cost-effective.

### Embodiments Configured for Heat Integration Comprising a Direct Contact Cooler and a Heat Pump in Energy Transfer Step a)

The combination of a direct contact cooler and heat pump allows for an efficient and flexible method for acid gas removal and the exploitation of fluid stream FS1 as a heat source to provide heat to the regeneration step c).

Fluid stream FS1 often has a low temperature which is not suited for direct steam generation. Also, fluid stream FS1 can induce corrosion in downstream equipment.

Large fluid stream, such as FS1, are often difficult to handle and transport and result in a significant pressure loss in equipment which needs to be overcome by additional pumps or fans for transporting the high-volume gas streams.

The use of a direct contact cooler has the advantage that the drawbacks described above can be reduced so that the use of fluid steam FS1 as a heat source becomes feasible.

The direct contact cooler has the advantage of a large exchange area between fluid stream FS1 and cooling medium stream CMS1, which reduces thermal resistances and maximizes the thermal efficiency. In addition, direct contact coolers usually have lower operating and capital costs than indirect heat exchangers due to a high heat transfer rate per volume and because fouling and corrosion is usually not a problem. Corrosion is a non-negligible problem in indirect heat exchangers in case of residual sulfur oxides (SOₓ) in the fluid stream FS1 which can cause dew point corrosion if the temperature of any metal in contact with FS1 is below the dew point of sulfuric acid, which typically is in the range of 110 to 170° C. Further, the pressure loss in a direct contact cooler is lower compared to an indirect gas-to-liquid heat exchanger. Therefore, the size of costly equipment, such as fans or blowers, required to compensate the pressure loss and to transport fluid stream FS2 to the absorber can be reduced or even avoided.

The use of a heat pump in combination with a direct contact cooler enables to bring the heat comprised in fluid stream FS1 to a level required in the regeneration step using electricity. Especially, if the heat transfer material, such as HTM1 or HTM2 of the (last) heat pump is water, steam required in the regeneration step c) can be directly produced with a comparatively low energy input.

Heat integration comprising a DCC and a heat pump allows the transfer of thermal energy from fluid streams FS1 having a comparatively low temperature. Also, the inventive heat integration results in a process in which corrosion is significantly reduced. Accordingly, the method of the present invention allows for improved heat integration in acid gas treatment. The operational and capital expenditures for operating and constructing the process according to the present invention are favorable and the method of the present invention is very flexible and can compensate load fluctuations of the fluid stream FS1.

The inventive integration of a direct contact cooler and a heat pump can be demonstrated by one of the subsequently described embodiments A, B and C in heat transfer step a).

Embodiment A demonstrate the integration of a direct contact cooler and a conventional heat pump.

Embodiment B demonstrates the integration of direct contact cooler and two serially connected heat pumps.

Embodiment C demonstrate the integration of a direct contact cooler and a so-called modified heat pump.

The embodiments of this invention are not intended to be exhaustive and are not supposed to be construed as being limited to the disclosed embodiments. Rather the embodiments are chosen and described to demonstrate the principles and practices of the present invention.

### Embodiment A: Conventional Heat Pump

The transfer of thermal energy from the fluid stream FS1 to the regeneration step c) of step a) preferably involves the combination of a direct contact cooler and a so-called conventional heat pump

The transfer step a) of embodiment A preferably comprises the steps of:
(i) transferring thermal energy from a fluid stream FS1 to a cooling material stream CMS1 in a direct contact cooler, to obtain a cooling material stream CMS2 and a fluid stream FS2 having a reduced thermal energy compared to fluid stream FS1;
(ii) transferring thermal energy from cooling material stream CMS2 to heat transfer material stream HTMS1 in a heat exchanger HE1 to obtain a heat transfer material stream HTMS2 having a higher thermal energy than heat transfer material stream HTMS1;
(iii) compressing the heat transfer material stream HTMS2 in one or more compression steps to obtain a gaseous heat transfer material stream HTMS3 having a higher pressure than heat transfer material stream HTMS2; and
(iv) transferring thermal energy from heat transfer material stream HTMS3 to the regeneration step c) to obtain a heat transfer material stream HTMS4;

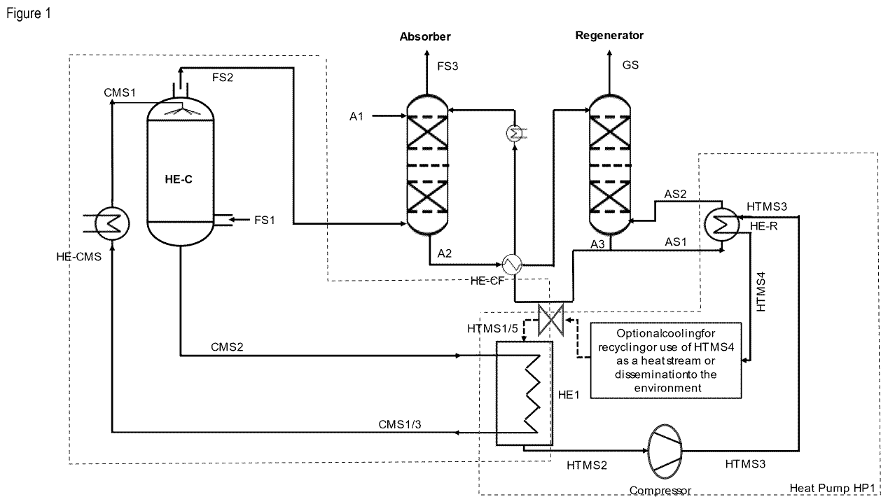

FIG. 1 demonstrates a process configuration according to embodiment A.

### Step i)

In step i) of embodiment A, thermal energy from a fluid stream FS1 is transferred to a cooling material stream CMS1 in a direct contact cooler, to obtain a cooling material stream CMS2 and a cooled fluid stream FS2.

The principles and the design of a direct contact cooler for step i) are described in the appropriate section “Direct Contact Cooler” above.

### Step ii)

In step ii) of embodiment A, thermal energy from cooling material stream CMS2 is preferably transferred to heat transfer material stream HTMS1 in a heat exchanger HE1 to obtain a gaseous heat transfer material stream HTMS2 having a higher thermal energy than heat transfer material stream HTMS1 and a cooling medium stream CMS3 having a lower thermal energy than cooling medium stream CMS2.

Heat exchanger HE1 preferably comprises:
an inlet for cooling medium stream CMS2 having a pressure p_{CMS2} and the temperature T_{CMS2} at the entrance of the inlet;
an outlet for cooling medium stream CMS3 having a pressure p_{CMS3} and a temperature T_{CMS3} at the exit of the outlet;
an inlet for a heat transfer material stream HTMS1 at a pressure p_{HTMS1} and the temperature T_{HTMS1} at the entrance of the inlet; and
an outlet for heat transfer medium stream HTMS2 having a pressure p_{HTMS2} and a temperature T_{HTMS2} at the exit of the outlet

Heat exchanger HE1 preferably is an indirect heat exchanger, such as an evaporator, in particularly HE1 is preferably a tubular heat exchanger, preferably shell-tube-heat exchanger, double-pipe heat exchanger and drip-type-heat exchanger, or a plate heat exchanger. Most preferably, heat exchanger HE1 is a shell-tube-heat exchanger or a plate heat exchanger.

In case of indirect heat transfer via the intermediate cooling cycle, heat exchanger HE1 is preferably designed in a manner so that following requirement are fulfilled:
the temperature T_{CMS2} is in the range of 25 to 120, preferably 30 to 100 and more preferably 40 to 70° C.
the temperature T_{HTMS2} is approximately 0.1 to 50 K, preferably 0.5 to 25 K and more preferably 1 to 10 K higher than T_{HTMS1}.
heat transfer material HTM1 in heat transfer material stream HTMS1 undergoes at least a partial phase transition from the liquid to the gas state.

Step ii) of embodiment A yields a substantially gaseous heat transfer material stream HTMS2 and a cooled cooling medium stream CMS3, which is preferably recycled as cooling medium stream CMS1 to step i). To confer the properties of cooling medium stream CMS1 on cooling medium stream CMS3, it may be preferably to implement an additional cooling step, e.g. by cooling medium CMS3 in a heat exchanger HE-CMS, which is preferably a cooler, more preferably an air or water cooler. Preferably cooling medium stream CMS3 is cooled to the temperature at which cooling medium stream CMS1 is introduced into the direct contact cooler HE-C.

Step iii)

After having transferred thermal energy to heat transfer medium stream HTMS2, themal energy is preferably further transferred in step iii) of embodiment A by compressing heat transfer medium stream HTMS2 in the heat pump HP1 to obtain a heat transfer medium stream HTMS3 having a higher pressure than heat transfer medium stream HTMS2.

Compression is preferably affected in a compressor.

A compressor is a device for increasing the pressure of an at least partially gaseous fluid.

The compressor is typically a positive displacement compressor or a dynamic compressor. Positive displacement compressors comprise reciprocating compressors that use pistons driven by a crankshaft to deliver fluids at higher pressures. Reciprocating compressors can be single or multi-staged. Positive displacement compressors also comprise rotary screw compressors, conical screw compressors, rotary vane compressors, rolling piston compressors or scroll compressors.

The compressor can also be a dynamic compressor, such as a centrifugal compressor or an axial compressor.

Preferably, the compressor is a rotary screw compressor, a centrifugal compressor, a piston compressor or an axial flow compressor.

Compression can be conducted in one compressor or a series of compressors, depending on the desired pressure increase of the heat transfer material HTM1. The heat transfer material HTM1 enters the compression step as heat transfer material stream HTMS2 at a pressure p_{HTMS2} and a temperature T_{HTSM2} and leaves the compression step as heat transfer material HTMS3 at a pressure p_{HTMS3} and a temperature T_{HTMS3}.

The pressure increase Δp (p_{HTMS3}−p_{HTMS2}) in the compression step is typically chosen so that the temperature of heat transfer medium stream HTMS3 is increased to a temperature which is required in the regeneration step c), as described below.

In a preferred embodiment, the compression step is conducted in a series of two or more compressors and the heat transfer material HTM1 is water. In this embodiment, an additional stream of heat transfer material HTM1 is additionally fed after each of the compressors in series to increase the amount of gaseous heat transfer material HTM1 produced at the expense of lowering the temperature of the stream. In this way it can be procured that enough steam is generated for regeneration step c). In addition, the addition of further heat transfer material HTM1 is energetically favorable compared to a scenario producing the same amount of gaseous heat transfer material HMT1, where no additional heat transfer material HTM1 is introduced after a compression step. Preferably, saturated steam is produced, and used for the heating in reboiler HE-R. By injecting water in between the compressor sections helps to lower the superheating of the steam. In addition, the injection of additional heat transfer material HTM1 results in a reduction of the volumetric flow rate and in a reduction of the power requirement of the subsequent compressors in the consecutive compression stages.

Step iii) of embodiment A yields a compressed heat transfer material stream HTMS3.

### Step iv)

In embodiment A, thermal energy is transferred to the regeneration step c) in step iv) by transferring thermal energy from the heat transfer medium stream HTMS3 to the regeneration step c) to obtain a heat transfer medium stream HTMS4 having a reduced themal energy content compared to HTMS3.

The transfer of thermal energy from the heat transfer material stream HTMS3 to the regeneration step c) may occur indirectly or directly as described below.

### Indirect Heat Transfer to the Regeneration Step c)

In a preferred variation of step iv), the transfer of thermal energy from the heat transfer material stream HTMS3 to the regeneration step c) is carried out in a heat exchanger HE-R in which the laden absorbent A2 obtained in step b) is heated prior to entering the regeneration step c).

Heat exchanger HE-R can replace or be in addition to the crossflow heat exchanger used to transfer heat from regenerated absorbent A3 to laden absorbent A2 prior to entering the regeneration step c).

The heat exchanger HE-R is preferably an indirect heat exchanger.

When heat exchanger HE-R is an indirect heat exchanger, HE-R preferably comprises:
an inlet for laden absorbent A2;
an outlet for laden absorbent A2 having an increased thermal energy compared to laden absorbent A2 at the inlet of heat exchanger HE-R;
an inlet for a second heat transfer medium stream HTMS1 having a pressure p_{SHTMS1} and the temperature T_{SHTMS1} at the entrance of the inlet; and
an outlet for a second heat transfer medium stream HTMS2 having a pressure p_{SHTMS2} and a temperature T_{SHTMS2} at the exit of the outlet.

More preferably the heat exchanger HE-R is a shell-and-tube exchanger or a plate exchanger.

This embodiment may be particularly useful in the case if fluid stream FS1 is flue gas and when an intermediate evaporation or flashing step is conducted after the crossflow heat exchanger HE-CF (see below). In this case, the at least partially laden absorbent stream A2 can be re-heated prior to entering the regenerator.

### Direct Heat Transfer to the Regeneration Step c)

In a most preferred embodiment of step iv), thermal energy is directly by transferring themal energy from the heat transfer medium stream HTMS3 to an absorbent stream AS1 withdrawn from the regenerator in step c) in a heat exchanger HE-R to obtain an absorbent stream AS2 having an increased thermal energy compared to absorbent stream AS1 and feeding AS2 to the regenerator in step c).

More preferably, the transfer of thermal energy is affected through a heat exchanger HE-R connected to the bottoms of the regenerator, in which heat exchange proceeds indirectly. Most preferably, the indirect heat exchanger HE-R is the reboiler. The reboiler is typically comprises an inlet connected to the bottom of the regenerator from which an absorbent stream AS1 enters the reboiler and outlet connected to an inlet at the bottom of the regenerator through which an absorbent stream AS2 exits the reboiler and reenters the regenerator.

The reboiler also comprises an inlet through which the second heat transfer material stream HTMS3 enters and an outlet through which the second heat transfer material stream HTMS4 exits the reboiler.

HE-R is preferably a reboiler selected from the group consisting of kettle type reboilers, thermosyphon reboilers and forced circulation reboilers.

Through the heating of absorbent stream AS2, acid gases, in particularly CO₂, are usually desorbed and water comprised in the absorbent is at least partially vaporized to stream to promulgate a stripping effect leading to a further liberation of acid gas from the laden absorbent.

Further details relating to the regeneration step c) and the recycling step d) are specified in a later section of this specification.

### Recycling

In a preferred embodiment, embodiment A comprises an additional recycling step R1) in which the heat transfer material stream HTMS4 obtained in step iv) is expanded to obtain a heat transfer medium stream HTMS5 having a reduced pressure compared to heat transfer material stream HTMS4 and which is at least partially recycled to step i) as heat transfer material stream HTMS1.

Expansion is preferably affected by to reduce the pressure p_{HTMS4} of heat transfer medium stream HTMS4 to a pressure p_{HTMS5} of heat transfer medium stream HTMS5. Expansion is preferably affected by a thermal expansion valve. Thermal expansion valves which can be used in the recycling step R1) are described in the Wikipedia article “Thermal Expansion Valve” at https://en.wikipedia.org/wiki/Thermal expansion valve. Pressure reduction Δp from p_{HTMS4} to P_{HTMS5} usually results in an adiabatic flash evaporation of a part of heat transfer medium stream HTMS4 and the autorefrigeration effect of the adiabatic flash evaporation lowers the temperature of the heat transfer medium stream HTMS4.

The expansion valve is preferably operated and designed in a manner that p_{HTMS5} equals p_{HTMS1} and T_{HTMS5} equals T_{HTMS1} SO that the heat transfer material stream HTMS5 can be preferably recycled to step 1 as heat transfer material stream HTMS1. The execution of the additional recycling step R1) has the advantage that the heat transfer materials HTM1 can be reused in a closed cycle heat pump to save material costs and resources or to prevent a contamination of the environment which would be associated with a loss of heat transfer material HTM1 in case an environmentally detrimental heat transfer material HTM1 is selected.

If the heat transfer material HTM1 is water/steam, it is not mandatory to expand the heat transfer material stream HHTM4 to recycle the water as the water may be discarded to the environment or used to transfer heat to other processes. In one embodiment of the present invention, it is therefore preferred not to recycle the heat transfer material stream HTMS4 directly to heat exchanger HE1.

### Heat Transfer Material

In embodiment A, the heat transfer material HTM1 can be any of the heat transfer materials mentioned above. Most preferably, the heat transfer material HTM used in embodiment A is water.

In embodiment A, heat transfer material streams HTMS 1 to 5 are streams of heat transfer material 1 in different stages of the heat pump HP1, wherein:
heat transfer material stream HTMS1 is the stream of heat transfer material HTM1 entering step i);
heat transfer material stream HTMS2 is the stream of heat transfer material HTM1 exiting step 1) and entering compression step ii);
heat transfer material stream HTMS3 is the stream of heat transfer material HTM1 exiting compression step 2) and entering step iii);
heat transfer material stream HTMS4 is the stream of heat transfer material HTM1 exiting step iv) and which optionally can enter recycling step R1);
heat transfer material stream HTMS5 is the stream of heat transfer material HTM1 exiting recycling step R1)

### Embodiment B: Serial Heat Pumps

In a preferred embodiment B, the transfer of thermal energy from fluid stream FS1 to the regeneration step c) is be conducted in two or more serially connected heat pumps.

The heat transfer step a) according to embodiment B preferably comprises the steps of:
i) transferring thermal energy from heat stream HS1 in a heat exchanger HE1 of the first heat pump HP1 to a heat transfer medium stream HTMS1 of a heat transfer material HTM1 to obtain a heat transfer medium stream HTMS2 having an increased thermal energy compared to heat transfer medium stream HTMS1;
ii) compressing heat transfer medium stream HTMS2 in the first heat pump HP1 to obtain a heat transfer medium stream HTMS3 having a higher pressure than heat transfer medium stream HTMS2;
iii) transferring thermal energy from heat transfer medium stream HTMS3 of the first heat pump HP1 in a heat exchanger HE2 of the second heat pump HP2 to a second heat transfer medium stream SHTMS1 of a second heat transfer material HTM2 to obtain a second heat transfer medium stream SHTMS2 having an increased thermal energy compared to the second heat transfer medium stream SHTMS1 and a heat transfer medium stream HTMS4 having a reduced thermal energy content compared to heat transfer medium stream HTMS3;
iv) compressing the second heat transfer medium stream SHTMS2 in the second heat pump HP2 to obtain a second heat transfer medium stream SHTMS3 having a higher pressure than the second heat transfer medium stream SHTMS2;
v) transferring thermal energy from the second heat transfer medium stream SHTMS3 of the second heat pump HP2 to the regeneration step c) to obtain a second heat transfer medium stream SHTMS4 having a reduced thermal energy content compared to SHTMS3.

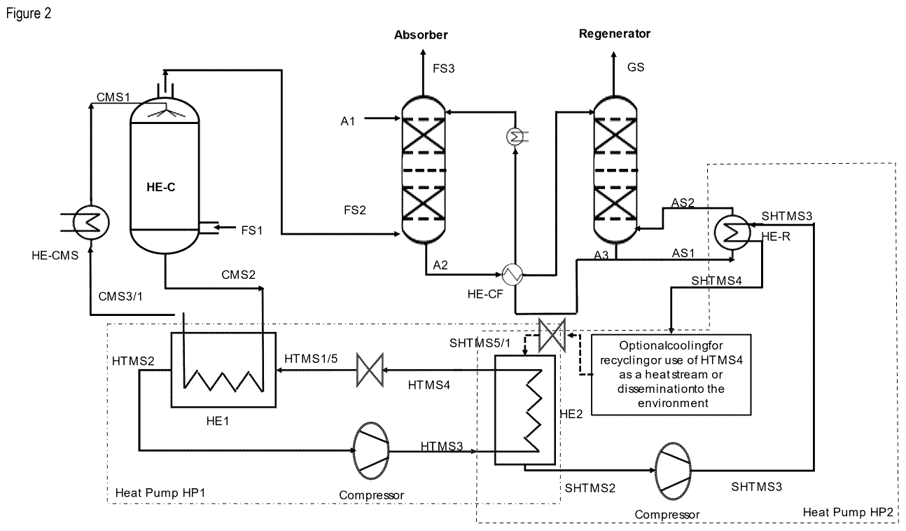

FIG. 2 demonstrates a process configuration implementing embodiment B.

### Step i)

Step i) of embodiment B is preferably carried out in substantially the same way as step i) in embodiment A.

### Step ii)

Step ii) of embodiment B is preferably carried out in substantially the same way as step ii) in embodiment B.

Step iii)

After increase of the pressure to obtain heat transfer material stream HTMS3, thermal energy is further transferred from heat pump HP1 to heat pump HP2 in a step iii) by transferring thermal energy from heat transfer medium stream HTMS3 of the first heat pump HP1 to a second heat transfer medium stream SHTMS1 of the second heat pump HP2 to obtain a second heat transfer medium stream SHTMS2 having an increased thermal energy compared to the second heat transfer medium stream SHTMS1 and a heat transfer medium stream HTMS4 having a reduced thermal energy content compared to heat transfer medium stream HTMS3.

The transfer of heat from heat transfer material stream HTMS3 to the second heat transfer material stream HTMS1 is preferably affected by a heat exchanger HE2. Heat exchanger HE2 is a device that is used to transfer thermal energy in the form of heat between heat transfer material stream HTMS3 and a second heat transfer medium stream SHTMS1 to obtain a second heat transfer medium stream SHTMS2 having an increased thermal energy compared to heat transfer medium SHTMS1 and a heat transfer material stream HTMS4 having a reduced thermal energy compared to heat transfer material stream HTMS3.

The heat exchanger HE2 is preferably an indirect heat exchanger.

When heat exchanger HE2 is an indirect heat exchanger, HE2 preferably comprises:
an inlet for heat transfer medium stream HTMS3 having a pressure p_{HTMS3} and the temperature T_{HTMS3} at the entrance of the inlet;
an outlet for heat transfer medium stream HTMS3 having a pressure p_{HTMS3} and a temperature T_{HTMS3} at the exit of the outlet;
an inlet for a second heat transfer medium stream SHTMS1 having a pressure p_{SHTMS1} and the temperature T_{SHTMS1} at the entrance of the inlet; and
an outlet for a second heat transfer medium stream SHTMS2 having a pressure p_{SHTMS2} and a temperature T_{SHTMS2} at the exit of the outlet.

More preferably the heat exchanger HE2 is a shell-and-tube exchanger or a plate exchanger.

Heat exchanger HE2 is preferably designed in a manner so that following requirement are fulfilled:
the temperature T_{HTMS3} is substantially higher than the boiling point of heat transfer material HTM2 in heat pump HP2 at the adjusted pressure, preferably 5 to 200 K or more, preferably 5 to 50 K or more, and most preferably 5 to 25K or more, higher than the boiling point of heat transfer material SHTM1 at the pressure p_{SHTMS1}.
the temperature T_{SHTMS2} is approximately 0.1 to 50 K, preferably 0.3 to 15 K and more preferably 1 to 5 K higher than T_{SHTMS1}.
heat transfer material HTM2 in heat pump HP2 in the second heat transfer material stream SHTMS1 undergoes at least a partial phase transition from the liquid to the gas state.
the pressure p_{SHTMS1} is preferably in the range of about 1 bar. It is possible that the pressure p_{SHTMS1} is below atmospheric pressure, such as 0.1 to 1 bar, but in a preferred embodiment, the pressure p_{SHTMS1} on the side of the second heat transfer material HTM2 is at atmospheric pressure or above, preferably in the range 0.7 to 2 bar, more preferably 0.8 to 1.5 bar and more preferably 0.9 to 1.2bar.

### Step iv)

In the preferred embodiment, the transfer of heat from heat pump HP1 to heat pump HP2, specifically to the second heat transfer material stream SHTMS2, is preferably followed by a compression step iv) in which the second heat transfer medium stream SHTMS2 in the second heat pump HP2 is compressed to obtain a second heat transfer medium stream SHTMS3 having a higher pressure than the second heat transfer medium stream SHTMS2.

Compression is preferably affected in a compressor.

A compressor is a device for increasing the pressure of an at least partially gaseous fluid.

The compressor is typically a positive displacement compressor or a dynamic compressor. Positive displacement compressors comprise reciprocating compressors that use pistons driven by a crankshaft to deliver fluids at higher pressures. Reciprocating compressors can be single or multi-staged. Positive displacement compressors also comprise rotary screw compressors, conical screw compressors, rotary vane compressors, rolling piston compressors or scroll compressors.

The compressor can also be a dynamic compressor, such as a centrifugal compressor or an axial compressor.

Preferably, the compressor is a rotary screw compressor, a centrifugal compressor, a piston compressor, or an axial flow compressor.

Compression can be conducted in one compressor or a series of compressors, depending on the desired pressure increase of the heat transfer material HTM2.

The heat transfer material HTM2 enters the compression step as heat transfer material stream SHTMS2 at a pressure p_{SHTMS2} and a temperature T_{SHTSM2} and leaves the compression step as heat transfer material stream SHTMS3 at a pressure p_{SHTMS3} and a temperature T_{SHTMS3}.

The pressure increase Δp (p_{SHTMS3}−p_{SHTMS2}) in the compression step is typically 1 to 20 bar, preferably 1.2 to 10 bar and more preferably 1.5 to 3 bar and the accompanying temperature increase is preferably 20 to 2000K, more preferably 25 to 6 K and most preferably 30 to 50 K.

In a preferred embodiment, the compression step is conducted in a series of two or more compressors and the heat transfer material HTM2 is water. In this embodiment, an additional stream of heat transfer material HTM2 is additionally fed after each of the compressors in series to increase the amount of gaseous heat transfer material HTM2 produced at the expense of lowering the temperature of the stream. In this way it can be procured that enough steam is generated for regeneration step c). In addition, the addition of further heat transfer material HTM2 is energetically favorable compared to a scenario producing the same amount of gaseous heat transfer material HMT2, where no additional heat transfer material HTM2 is introduced after a compression step. Preferably, saturated steam is produced, and used for the heating in reboiler HE-R. By injecting water in between the compressor sections helps to lower the superheating of the steam. In addition, the injection of additional heat transfer material HTM2 results in a reduction of the volumetric flow rate and in a reduction of the power requirement of the subsequent compressors in the consecutive compression stages.

Step v) Transfer of Thermal Energy from SHTSM3 to Regeneration Step c)

According to the preferred embodiment of the present invention, thermal energy is transferred to the regeneration step c) in step v) by transferring thermal energy from the second heat transfer medium stream SHTMS3 of the second heat pump HP2 to the regeneration step c) to obtain a second heat transfer medium stream SHTMS4 having a reduced thermal energy content compared to SHTMS3.

The transfer of thermal energy from the second heat transfer material stream SHTMS3 to the regeneration step c) may occur indirectly or directly substantially in the same way as the transfer of thermal energy from heat transfer material stream HTMS3 to the regeneration step c) occurs in step iv) of embodiment A.

### Open-Loop-Heat Pump

In a preferred embodiment of embodiment B, the last heat pump of the serial connected heat pumps is designed as an open-loop heat pump in which the heat transfer material stream exiting the heat exchanger HE-R is not recycled to heat exchanger HE-2. This is even more preferentially the case, if the heat transfer material used in the last of the serially connected heat pumps is water. Open loop-heat pumps have the previously described advantages.

### Recycling Step

In a further preferred embodiment, embodiment B comprises an additional recycling step R1) in which the heat transfer material stream HTMS4 obtained in step iii) of embodiment B is expanded to obtain a heat transfer medium stream HTMS5 having a reduced pressure compared to heat transfer material stream HTMS4 and which is at least partially recycled to step i) of embodiment A as heat transfer material stream HTMS1. Recycling step R1 is carried out substantially in the same way as recycling step R1 is carried out in embodiment A.

In a further preferred embodiment, embodiment B comprises an additional recycling step R2) in which the second heat transfer material stream SHTMS4 obtained in step v) of embodiment B is expanded to obtain a second heat transfer medium stream SHTMS5 having a reduced pressure compared to the second heat transfer material stream SHTMS4 and which is at least partially recycled to step 3) as second heat transfer material stream SHTMS1.

Expansion is preferably affected by to reduce the pressure p_{SHTMS4} of heat transfer medium stream SHTMS4 to pressure p_{SHTMS1} of heat transfer medium stream SHTMS1. Expansion is preferably affected by a thermal expansion valve. Thermal expansion valves which can be used in step 4) are described in the Wikipedia article “Thermal Expansion Valve” at https://en.wikipedia.org/wiki/Thermal expansion valve.

Pressure reduction Δp from p_{SHTMS4} to p_{SHTMS5} results in the adiabatic flash evaporation of a part of heat transfer medium stream SHTMS4 and the auto-refrigeration effect of the adiabatic flash evaporation lowers the temperature of the heat transfer medium stream SHTMS4.

The expansion valve is preferably operated and designed in a manner that p_{SHTMS5} equals p_{SHTMS1} and T_{SHTMS5} equals T_{SHTMS1}.

Heat transfer medium stream SHTMS5 is preferably recycled to step 1) of the evaporation process as heat transfer material stream SHTMS1.

The execution of at least one of the additional recycling steps R1 and R2 in embodiment B has the advantage that the heat transfer materials HTM1 and HTM2 can be reused in a closed cycle heat pump in order to save material costs or to prevent a contamination of the environment which would be associated with a loss of heat transfer material HTM1 or HTM2 in case a environmentally detrimental heat transfer material HTM1 or HTM2 is selected.

If the heat transfer material HTM2 is water/steam, it is not mandatory to expand the second heat transfer material stream SHTM4 to recycle the water as the water may be discarded to the environment or used to transfer heat to other processes But preferably, the method of the present invention also comprises recycling step R2 if the heat transfer material HTM2 is water or another heat transfer material HTM2, which is especially preferably in area where water is a scarce resource.

### Heat Transfer Materials

The heat transfer material HTM2 is a working fluid used in heat pump HP2 embodiment B to transport thermal energy from heat exchanger HE2 to heat exchanger HE-R. Preferably, the heat transfer material HTM2 can undergo at least a partial phase transition from the liquid to the gas state upon transfer of thermal energy in heat exchanger HE2.

Preferably, the heat transfer material HTM2 can also undergo at least a partial phase transition from the gas to the liquid state upon transfer of thermal energy in heat exchanger HE-R.

Heat transfer material HTM2 is preferably a substance whose boiling point at p_{SHTMS1} IS lower than T_{HTMS3} at p_{HTMS3} and below the temperature at which the regenerator is operated.

Accordingly, besides water, any other material whose boiling point at the pressure p_{SHTMS1} is below 150° C., preferably 140° C. and more preferably below 130° C. is preferred.

The most preferred heat transfer material HTM2 is water because water can at least partially undergo a phase transition to steam in heat exchanger HE2.

The heat transfer material HTM1 used in heat pump HP1 of embodiment B preferably has a lower boiling point under the conditions of heat pump HP1 than heat transfer material HTM2. Preferably, HTM1 can be selected from the group consisting of ammonia, butane, R123zd(e), R1224yd(z), air, CO₂, water, chlorofluorocarbon, hydrochlorofluorocarbon, hydrofluorocarbon, hydrofluoro-olefine, hydrochlorofluoro-olefine, hydrocarbon, perfluoro (2-methyl-3-pentanone).

In embodiment B, the combination of one of ammonia or butane for heat transfer material HTM1 and water for heat transfer material HTM2 is preferred.

In embodiment B, heat transfer material streams HTMS 1 to 5 are streams of heat transfer material 1 in different stages of the heat pump HP1, wherein:
heat transfer material stream HTMS1 is the stream of heat transfer material HTM1 entering step i);
heat transfer material stream HTMS2 is the stream of heat transfer material HTM1 exiting step 1) and entering compression step ii);
heat transfer material stream HTMS3 is the stream of heat transfer material HTM1 exiting compression step 2) and entering step iii);
heat transfer material stream HTMS4 is the stream of heat transfer material HTM1 exiting step iv) and which optionally can enter recycling step R1);
heat transfer material stream HTMS5 is the stream of heat transfer material HTM1 exiting recycling step R1)
the second heat transfer material stream SHTMS1 is the stream of heat transfer material HTM2 entering step 3);
the second heat transfer material stream SHTMS2 is the stream of heat transfer material HTM2 exiting step 3) and entering compression step 4);
the second heat transfer material stream SHTMS3 is the stream of heat transfer material HTM2 exiting compression step 4) and entering step 5);
the second heat transfer material stream SHTMS4 is the stream of heat transfer material HTM2 exiting step 5) and which optionally can enter recycling step R2);
the second heat transfer material stream SHTMS5 is the stream of heat transfer material HTM2 exiting recycling step R2) and which can be recycled to step 3) as the second heat transfer material stream SHTMS1.

### Embodiment C): Modified Heat Pump

Embodiment C makes use of a so-called modified heat pump in which heat transfer is affected from fluid stream FS1 to a heat transfer medium stream HTMS1 in a heat exchanger HE1 to obtain a liquid heat transfer material stream HTMS2a and evaporation of HTMS2a is carried out by a separate evaporation means as described below. Embodiment C has the advantage, that steam can also be directly produced from fluid streams FS1. This allows the heat integration of streams from which steam would not be directly producible. In addition, a process comprising a modified heat pump may be designed in a manner so that the operating and capital costs are comparably low.

The heat transfer step a) of embodiment C preferably comprises the steps of:
(i) transferring thermal energy from a fluid stream FS1 to a liquid heat transfer material stream HTMS1 of a heat transfer material HTM1 in a direct contact cooler to obtain a liquid heat transfer material stream HTMS2a;
(ii) expanding the heat transfer medium stream HTMS2a in one or more expansion steps to obtain a gaseous heat transfer material stream HTMS2b (g) having a lower pressure than heat transfer material stream HTMS2a;
(iii) compressing the heat transfer material stream HTMS2b (g) in one or more compression steps to obtain a gaseous heat transfer material stream HTMS3 having a higher pressure than heat transfer material stream HTMS2b (g); and
(iv) transferring thermal energy from heat transfer material stream HTMS3 to the regeneration step c) to obtain a heat transfer material stream HTMS4.

### Step i)

In step i) of embodiment C, the transfer of thermal energy from fluid stream FS1 to the heat transfer material stream HTMS1 in the modified heat pump can be carried out directly or indirectly.

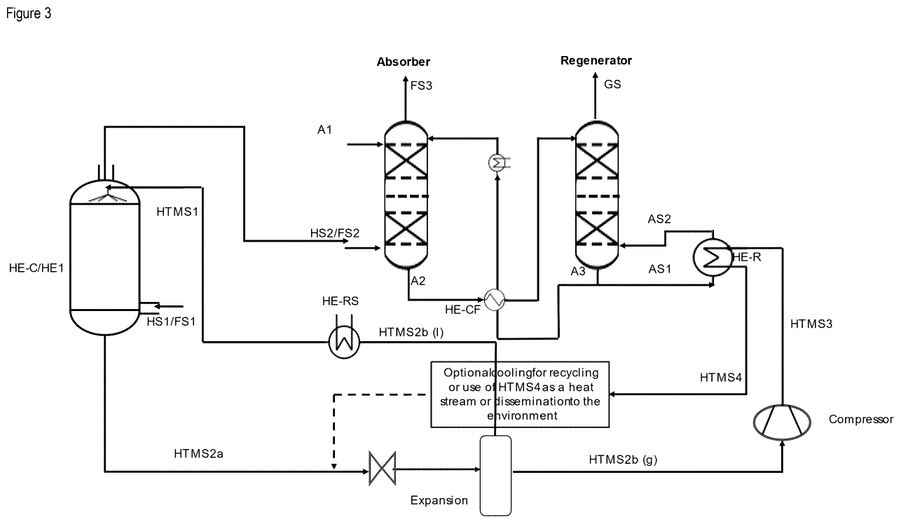

FIG. 3 represents a process configuration of embodiment C in which heat transfer from fluid stream FS1 to heat transfer material stream is carried out directly.

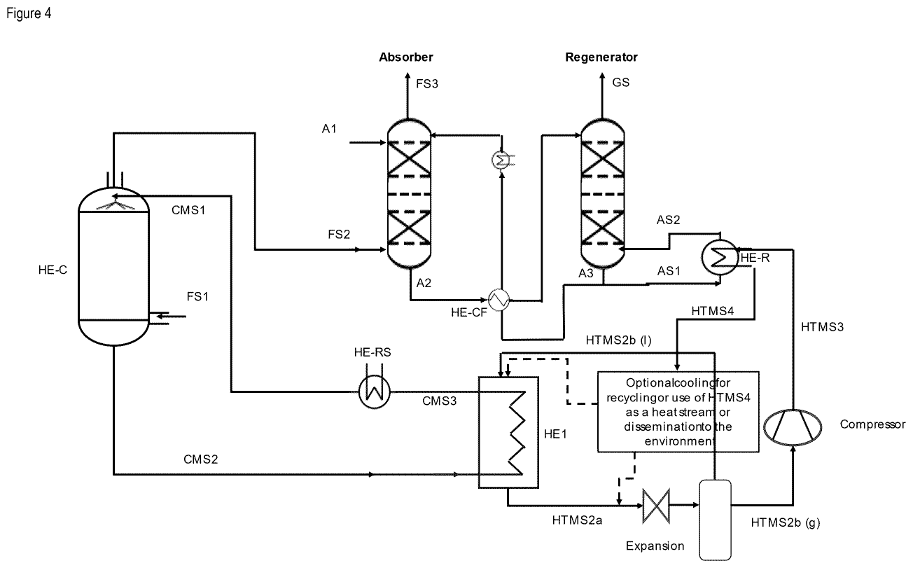

FIG. 4 represents a process configuration of embodiment C with indirect heat transfer via an cooling medium cycle, comprising the cooling medium streams CMS1, CMS2 and CMS3.

Direct heat transfer can be carried out in substantially the same way as step i) in embodiment A is carried out, with the proviso that the cooling material CM1 used in the direct contact cooler is the heat transfer material HTM1 of the modified heat pump.

According, direct contact cooling comprises the transfer of thermal energy from fluid stream FS1 to the heat transfer material stream HTMS1 to yield a heat transfer material stream HTMS2a having a higher thermal energy than heat transfer material stream HTMS1. Accordingly, heat transfer material stream HTMS1 and HTMS2a correspond to cooling medium streams CMS1 and CMS2 in step i) of embodiment A.

Heat transfer from fluid stream FS1 can also be carried out indirectly. Indirect heat transfer can be carried out substantially the same way as step i) and ii) in embodiment A are carried out, with the proviso that a phase transition of heat transfer material HTM1 in heat exchanger HE1 does not occur in step i) and a liquid heat transfer material stream HTMS2a is obtained.

Step i) of embodiment C yields a liquid heat transfer material stream HTMS2a.

### Step ii)

After having transferred thermal energy to heat transfer material stream HTMS2a, the liquid heat transfer material stream HTMS2a is expanded in one or more expansion steps to obtain a gaseous heat transfer material stream HTMS2b (g) having a lower pressure than heat transfer material stream HTMS2a.

An expansion step is preferably carried out by a means suitable for affecting such an expansion. Expansion is preferably carried out as a flash evaporation of heat transfer material stream HTMS2a through an expansion or throttling valve into a vessel having a lower pressure than p_{HTMS2a}. The vessel preferably has a liquid outlet and a vapor outlet. More preferably, the vessel is a flash drum. The stream of heat transfer material HTMS2a which remains in a liquid form after evaporation, HTMS2a (I), is preferably recycled as heat transfer material stream HTMS1 to step i), as further described below. The pressure in the evaporation step ii) is preferably decreased to a value of 10 to 900 mbar, preferably a value of 30 to 700 mbar and more preferably a value of 50 to 300 mbar.

The pressure drop can be affected in one evaporation step or in two or more evaporation steps.

The decrease in pressure usually results in temperature drop of preferably 2 to 30 K, more preferably 3 to 20 K and most preferably 5 to 15 K and a partial evaporation of heat transfer material stream HTMS2a to obtain a gaseous heat transfer material stream HTMS2b (g) while the other part of heat transfer material stream HTMS2a remains in the liquid state to obtain a liquid heat transfer material stream HTMS2b (I). Through the pressure decrease, usually about 0.5 to 10, preferably 1 to 8 and more preferably 2 to 5 weight percent of the original mass of heat transfer material stream HTMS2a will undergo a phase transition to the gaseous state. The liquid part of heat transfer material stream HTMS2b (I) is preferably recycled as heat transfer material stream HTMS1 to heat exchanger HE1 in step i) or ia), respectively. To confer upon the liquid part of heat transfer material stream HTMS2b (I) the properties of heat transfer material stream HTMS1, it may be necessary to conduct one or more compression and or cooling steps. Preferably, heat transfer material stream HTMS2b (I) is cooled in heat exchanger HE-RS, which is preferably a water or air cooler.

Step iii)

After having expanded heat transfer medium stream HTMS2a to obtain a heat transfer material stream HTMS2b (g), thermal energy is preferably further transferred in step iii) by compressing heat transfer medium stream HTMS2b (g) in the heat pump HP1 to obtain a heat transfer medium stream HTMS3 having a higher pressure than heat transfer medium stream HTMS2b (g).

Compression is preferably affected in a compressor.

A compressor is a device for increasing the pressure of an at least partially gaseous fluid.

The compressor is typically a positive displacement compressor or a dynamic compressor. Positive displacement compressors comprise reciprocating compressors that use pistons driven by a crankshaft to deliver fluids at higher pressures. Reciprocating compressors can be single or multi-staged. Positive displacement compressors also comprise rotary screw compressors, conical screw compressors, rotary vane compressors, rolling piston compressors or scroll compressors.

The compressor can also be a dynamic compressor, such as a centrifugal compressor or an axial compressor.

Preferably, the compressor is a rotary screw compressor, a centrifugal compressor, a piston compressor or an axial flow compressor.

Compression can be conducted in one compressor or a series of compressors, depending on the desired pressure increase of the heat transfer material HTM1.

The heat transfer material HTM1 enters the compression step as heat transfer material stream HTMS2b (g) at a pressure p_{HTMS2b} and a temperature T_{HTSM2b} and leaves the compression step as heat transfer material HTMS3 at a pressure p_{HTMS3} and a temperature T_{HTMS3}.

The pressure increase Δp (p_{HTMS3}−p_{HTMS2b}) in the compression step is typically chosen so that the temperature of heat transfer medium stream is increased to a temperature required in the regeneration step b). Preferably the pressure increase Δp is selected to achieve a temperature of 100 to 150° C., preferably 105 to 140° C. and most preferably 110 to 130° C. in the heat exchanger HE-R, which is preferably the reboiler of the regenerator in step b).

In a preferred embodiment, the compression step iii) is conducted in a series of two or more compressors and the heat transfer material HTM1 is water. In this embodiment, an additional stream of heat transfer material HTM1 is additionally fed after each of the compressors in series to increase the amount of gaseous heat transfer material HTM1 produced at the expense of lowering the temperature of the stream. In this way it can be procured that enough steam is generated for regeneration step c). In addition, the addition of further heat transfer material HTM1 is energetically favorable compared to a scenario producing the same amount of gaseous heat transfer material HMT1, where no additional heat transfer material HTM1 is introduced after a compression step. Preferably, saturated steam is produced, and used for the heating in reboiler HE-R. By injecting water in between the compressor sections helps to lower the superheating of the steam. In addition, the injection of additional heat transfer material HTM1 results in a reduction of the volumetric flow rate and in a reduction of the power requirement of the subsequent compressors in the consecutive compression stages.

### Step iv):

In embodiment C, thermal energy is transferred to the regeneration step c) in step iv) by transferring thermal energy from the heat transfer medium stream HTMS3 to the regeneration step c) to obtain a heat transfer medium stream HTMS4 having a reduced themal energy content compared to HTMS3.

The transfer of thermal energy from the heat transfer material stream HTMS3 to the regeneration step c) may occur indirectly or directly as described under step iv) of embodiment A.

### Open-Loop Heat Pump

In a preferred embodiment of embodiment C, the modified heat pump is designed as an open-loop heat pump in which the heat transfer material stream HTM4 exiting the heat exchanger HE-R is not recycled to heat exchanger HE1. This is even more preferably the case, if the heat transfer material used in the last of the serially connected heat pumps is water. Open loop-heat pumps have the previously described advantages.

### Use of HTMS4

Heat transfer material HTM4 in embodiment C can also be recycled or used to provide heat to other parts of the process or other heat consumers.

Recycling may require an additional cooling step to cool heat transfer material stream HTMS4 obtained at the outlet of heat exchanger HE-R prior to recycling it as heat transfer material stream HTMS1 or cooling medium stream CMS1. The cooling step preferably comprises the heat transfer to a part of the process which requires additional heat. For example, heat transfer material stream HTMS4 may be additionally used to heat laden absorbent stream A2 prior to its introduction to the regeneration step c).

Alternatively, heat transfer material stream HTMS4 may be used in other processes on site of the AGRU or other heat consumers to provide heat.

In further preferred embodiment heat transfer material stream HTMS4 may be mixed with heat transfer material stream HTMS2a. In this case, heat transfer material stream HTMS2 or cooling medium stream CMS1 may need to be supplemented by fresh heat transfer material HTM1 or fresh cooling medium CM1.

### Heat Transfer Material HTM1

The heat transfer material HTM1 used in the modified heat pump is preferably water, especially when cooling medium CM1 of the direct contact cooler is also the heat transfer material HTM1 of the modified heat pump HP1. In this case, steam can be directly produced from the cooling medium stream CMS1 by steps ii) and iii) of embodiment C. This embodiment requires comparably low investments and can be easily implemented.

### Acid Gas Absorption Process-Absorption Step b)

According to the present invention, fluid stream FS2 obtained in energy transfer step a) is deacidified in an absorption step b) in which the cooled fluid stream FS2 is contacted with an absorbent A1 in an absorber to obtain an absorbent A2 laden with acid gases and an at least partly deacidified fluid stream.

### Absorbent:

The absorbent comprises at least one amine.

The following amines are preferred:
i) amines of the formula I:

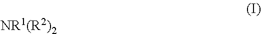

in which R1 is selected from C₂-C₆-hydroxyalkyl groups, C₁-C₆-alkoxy-C₂-C₆-alkyl groups, hydroxy-C₁-C₆-alkoxy-C₂-C₆-alkyl groups and 1-piperazinyl-C₂-C₆-alkyl groups, and R² is independently selected from H, C₁-C₆-alkyl groups and C₂-C₆-hydroxyalkyl groups;
ii) amines of the formula II:

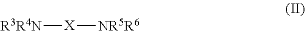

in which R³, R⁴, R⁵ and R⁶ are independently selected from H, C₁-C₆-alkyl groups, C₂-C₆-hydroxyalkyl groups, C₁-C₆-alkoxy-C₂-C₆-alkyl groups and C₂-C₆-aminoalkyl groups, and X is a C₂-C₆-alkylene group, —X¹—NR⁷—X²— or —X¹—O—X²—, in which X¹ and X² are independently C₂-C₆-alkylene groups and R⁷ is H, a C₁-C₆-alkyl group, C₂-C₆-hydroxyalkyl group or C₂-C₆-aminoalkyl group;
iii) 5- to 7-membered saturated heterocycles which have at least one nitrogen atom in the ring and may comprise one or two further heteroatoms selected from nitrogen and oxygen in the ring, and
iv) mixtures thereof.

Specific examples of amines usable with preference are:
i) 2-aminoethanol (monoethanolamine), 2-(methylamino) ethanol, 2-(ethylamino) ethanol, 2-(n-butylamino) ethanol, 2-amino-2-methylpropanol, N-(2-aminoethyl) piperazine, methyldiethanolamine, ethyldiethanolamine, dimethylaminopropanol, t-butylaminoethoxyethanol (TBAEE), 2-amino-2-methylpropanol, diisoproanolamine (DIPA);
ii) 3-methylaminopropylamine, ethylenediamine, diethylenetriamine, triethylenetetramine, 2,2-dimethyl-1,3-diaminopropane, hexamethylenediamine, 1,4-diaminobutane, 3,3-iminobispropylamine, tris(2-aminoethyl) amine, bis(3-dimethylaminopropyl) amine, tetramethylhexamethylenediamine;
iii) piperazine, 2-methylpiperazine, N-methylpiperazine, 1-hydroxyethylpiperazine, 1,4-bishydroxyethylpiperazine, 4-hydroxyethylpiperidine, homopiperazine, piperidine, 2-hydroxyethylpiperidine, triethylendiamine (TEDA) and morpholine; and
iv) mixtures thereof.

In a preferred embodiment, the absorbent comprises at least one of the amines monoethanolamine (MEA), methylaminopropylamine (MAPA), piperazine (PIP), diethanolamine (DEA), triethanolamine (TEA), diethylethanolamine (DEEA), diisopropanolamine (DIPA), aminoethoxyethanol (AEE), tert-butylaminoethoxyethanol (TBAEE), dimethylaminopropanol (DIMAP) and methyldiethanolamine (MDEA), triethylendiamine (TEDA) or mixtures thereof.

Further amines that may be introduced into the process are tert-butylaminopropanediol, tert-butylaminoethoxyethylmorpholine, tert-butylaminoethylmorpholine, methoxyethoxyethoxyethyl-tert-butylamine, tert-butylaminoethylpyrrolidone.

The amine is preferably a sterically hindered amine or a tertiary amine. A sterically hindered amine is a secondary amine in which the amine nitrogen is bonded to at least one secondary carbon atom and/or at least one tertiary carbon atom; or a primary amine in which the amine nitrogen is bonded to a tertiary carbon atom. A preferred sterically hindered amine is t-butylaminoethoxyethanol. A preferred tertiary amine is methyldiethanolamine and triethylendiamine (TEDA).

If the aim is to remove the CO₂ present in the fluid stream completely or virtually completely, the absorbent preferably additionally comprises an activator when the amine present in the absorbent is a sterically hindered amine or a tertiary amine. The activator is generally a sterically unhindered primary or secondary amine. In these sterically unhindered amines, the amine nitrogen of at least one amino group is bonded only to primary carbon atoms and hydrogen atoms. If the aim is merely to remove a portion of the gases present in the fluid stream, for example the selective removal of H₂S from a fluid stream comprising H₂S and CO₂, the absorbent preferably does not comprise any activator.

The sterically unhindered primary or secondary amine which can be used as activator is selected, for example, from alkanolamines, such as monoethanolamine (MEA), diethanolamine (DEA), ethylaminoethanol, 1-amino-2-methyl-propan-2-ol, 2-amino-1-butanol, 2-(2-aminoethoxy) ethanol and 2-(2-aminoethoxy) ethanamine, polyamines, such as hexamethylenediamine, 1,4-diaminobutane, 1,3-diaminopropane, 3-(methylamino) propylamine (MAPA), N-(2-hydroxyethyl)ethylenediamine, 3-(dimethylamino) propylamine (DMAPA), 3-(diethylamino) propylamine, N,N′-bis(2-hydroxyethyl)ethylenediamine, 5—, 6- or 7-membered saturated heterocycles having at least one NH group in the ring, which may comprise one or two further heteroatoms selected from nitrogen and oxygen in the ring, such as piperazine, 2-methylpiperazine, N-methylpiperazine, N-ethylpiperazine, N(2-hydroxyethyl) piperazine, N-(2-aminoethyl) piperazine, homopiperazine, piperidine and morpholine.

Particular preference is given to 5—, 6- or 7-membered saturated heterocycles which have at least one NH group in the ring and may comprise one or two further heteroatoms selected from nitrogen and oxygen in the ring. Very particular preference is given to piperazine.

The molar ratio of activator to sterically hindered amine or tertiary amine is preferably in the range from 0.05 to 1.0, more preferably in the range from 0.05 to 0.7.

The absorbent generally comprises 10% to 60% by weight of amine.

In one embodiment, the absorbent comprises the tertiary amine methyldiethanolamine and the activator piperazine.

In a preferred embodiment, the absorbent comprises
A) at least one cyclic amine compound having solely tertiary amine groups and
B) at least one cyclic amine compound having at least one sterically unhindered secondary amine group,
wherein the total concentration of A)+B) is 10 to 60% by weight.

Such absorbents are disclosed in EP2391435. Most preferably amine A) is triethylendiamine (TEDA) and activator amine B) is piperazine.

The absorbent may additionally comprise physical solvents. Suitable physical solvents are, for example, N-methylpyrrolidone, tetramethylenesulfone, oligoethylene glycol dialkyl ethers such as oligoethylene glycol methyl isopropyl ether (SEPASOLV MPE), oligoethylene glycol dimethyl ether (SELEXOL). The physical solvent is generally present in the absorbent in amounts of 1% to 60% by weight, preferably 10% to 50% by weight, especially 20% to 40% by weight.

In a preferred embodiment, the absorbent comprises less than 10% by weight, for example less than 5% by weight, in particular less than 2% by weight of inorganic basic salts, such as potassium carbonate for example.

The absorbent may also comprise additives, such as corrosion inhibitors, antioxidants, enzymes, antifoams etc. In general, the amount of such additives is in the range of about 0.01-3% by weight of the absorbent.

The absorber may be supplied with fresh absorbent, or the absorber may be supplied with absorbent regenerated in the recycling step c). The supply of fresh absorbent means that the components of the absorbent are yet to pass through steps b) to d). The supply of regenerated absorbent requires at least a portion of the components of the absorbent to have passed through steps b) to d).

The absorbent is preferably aqueous. This means that the wide variety of different constituents of the absorbent, such as amine, methanol, physical solvents, additives, may be mixed with water in the amounts mentioned above.

### Absorber:

The fluid stream FS2 is preferably contacted with the absorbent in step b) in an absorber.

The absorber is preferably an absorption tower or an absorption column, for example a column with random packing or structured packing or a tray column.

The absorber generally comprises an absorption zone and optionally a rescrubbing zone.

The absorption zone is deemed to be the section of the absorption column in which the fluid stream comes into mass transfer contact with the absorbent.

The fluid stream is preferably contacted in countercurrent with the absorbent in the absorption zone.

To improve contact with the absorbent and provide a large mass transfer interface, the absorption zone generally comprises internals, for example random packings, structured packings and/or trays, such as valve trays, bubble-cap trays, Thormann trays or sieve trays.

If the absorption zone comprises random packings or structured packings, the height of the random packings/structured packings of the absorption zone is preferably in the range from 5 to 20 m, more preferably in the range from 6 to 15 m and most preferably in the range from 8 to 14 m.

If the absorption zone comprises trays, the number of trays in the absorption zone is preferably in the range from 8 to 30, more preferably 12 to 25 and most preferably 15 to 23 trays.

In the case of columns with random packings or structured packings, the absorption zone may be divided into one or more sections, preferably 2 to 4 sections. Bearing and holding trays and/or distributor trays may be disposed between the individual sections of the absorption zone, and these improve the distribution of the absorbent over the entire cross section of the column.

The temperature of the absorbent introduced into the absorption zone is generally about 0 to 60° C., preferably 10 to 50° C. and more preferably 25 to 50° C. The pressure in the absorber depends on the pressure and the type of fluid stream FS2 entering the absorber.

When fluid stream FS2 is a synthesis gas, the pressure in the absorber is typically in the range from 5 to 120 bar, more preferably 10 to 100 bar and most preferably 10 to 60 bar has.

When fluid stream FS2 is a flue gas, the pressure in the absorber is typically preferably in the range of 0.7 to 1.5 bar, more preferably 0.8 to 1.3 bar and more preferably 0.9 to 1.2 bar. Most preferably, the absorber is operated at atmospheric pressure, when fluid stream FS2 is a flue gas.

The feed point for the fluid stream introduced is preferably below or in the lower region of the absorption zone. The feed is preferably evenly distributed over the cross-section of the absorber via a gas distributor.

The absorber may comprise one or more feed points for the absorbent introduced. For instance, the absorber may comprise a feed point for fresh absorbent A1 and a feed point for regenerated absorbent A3. Fresh and regenerated absorbent may alternatively be fed into the absorber together via one feed point. The one or more feed points are preferably above or in the upper region of the absorption zone. It is also possible to feed in individual constituents of the absorbent, such as make-up water, via the feed point for fresh absorbent.

If the absorber has an optional rescrubbing zone, the feed is preferably between the absorber zone and the rescrubbing zone.

The contacting of the fluid stream with the absorbent in the absorption zone affords an at least partly deacidified fluid stream FS3 and an absorbent laden with acid gases. In the upper region of the absorber, there is generally a draw point for the deacidified fluid stream FS3. A demister may be mounted in the region of the draw point, in order to separate out any liquid residues of the absorbent or of the scrubbing agent from the exiting fluid stream.

There is generally a draw point for the laden absorbent FS2 in the lower region of the absorber, preferably at the bottom.

The at least partly deacidified fluid stream FS3 may optionally be contacted with a scrubbing liquid in one or more rescrubbing zones (collectively referred to as “rescrubbing zone”).

The scrubbing liquid is more preferably an aqueous liquid. The scrubbing liquid may be a liquid intrinsic to the process, i.e., an aqueous liquid obtained elsewhere in the process, or aqueous liquids supplied from the outside. Preferably, the scrubbing liquid comprises a condensate (called absorber top condensate) formed in a downstream cooling operation on the deacidified fluid stream and/or fresh water.

The rescrubbing zone is generally a section of the absorber above the feed point of the absorbent.

The rescrubbing zone preferably has random packings, structured packings and/or trays to intensify the contact between the fluid stream and the scrubbing liquid. The rescrubbing zone especially has trays, especially valve trays, bubble-cap trays, Thormann trays or sieve trays.

The rescrubbing zone comprises preferably 1 to 7, more preferably 2 to 6 and most preferably 3 to 5 trays, or a packing height (random packings/structured packings) of preferably 1 to 6 m, more preferably 2 to 5 and most preferably 2 to 3 m.

The scrubbing liquid is generally introduced above the rescrubbing zone or into the upper region of the rescrubbing zone. The scrubbing liquids used may be the abovementioned scrubbing liquids.

The scrubbing liquid may be recycled via the rescrubbing zone. This is achieved by collecting the scrubbing liquid below the rescrubbing zone, for example by means of a suitable collection tray, and pumping it to the upper end of the rescrubbing zone by means of a pump. The recycled scrubbing liquid may be cooled, preferably to a temperature of from 20° C. to 70° C., in particular 30° C. to 60° C. This is advantageously achieved by recirculating the scrubbing liquid through a cooler. In order to avoid any accumulation of scrubbed-out absorbent constituents in the scrubbing liquid, a substream of the scrubbing liquid is preferably discharged from the rescrubbing zone.

By the contacting of the at least partly deacidified fluid stream FS3 with a scrubbing liquid, it is possible to scrub out entrained absorbent constituents, such as amines. The contacting with an aqueous scrubbing liquid can additionally improve the water balance of the process when more water is discharged via the exiting streams than is introduced via the entering streams.

A deacidified fluid stream FS3, as described above, is preferably drawn off via a draw point in the upper part of the absorber.

Optionally, the deacidified fluid stream FS3 may be guided through a condenser. Condensers used may, for example, be condensers having cooling coils or helical tubes, plate heat exchangers, jacketed tube condensers and shell and tube heat exchangers.

The condenser is generally operated at a temperature in the range from 10 to 60° C., preferably 20 to 50° C., more preferably 20 to 30° C.

The water content of the deacidified fluid stream is generally 80-100% of the saturation concentration of water in the fluid stream under the existing temperature and pressure conditions.

Step b) affords an absorbent A2 at least partially laden with acid gases. The laden absorbent A2 may be fed directly to the regeneration step c).

### Expansion Step (Optional):

In a particular embodiment of the process of the invention, an expansion step is first conducted on the laden absorbent A2 before it is introduced into the regeneration step c).

In the expansion step, the laden adsorbent A2 is generally guided into one or more expansion vessels.

If the pressure in the absorber is higher than the pressure in the regenerator, the laden absorbent can be expanded through a throttle valve into an expansion vessel.

If fluid stream FS2 is a syngas, the laden adsorbent is preferably expanded to a pressure of 3 to 15 bar, preferably 4 to 12 and more preferably 5 to 10 bar.

The expansion generally leads to the desorption the so-called flash gas. The flash gas may be guided back into the absorption by means of a compressor or incinerated for energy generation or flared off in situ.

If the fluid stream FS2 is a flue gas, the laden absorbent is preferably pumped to an expansion vessel which is located downstream of a crossflow heat exchanger HE-CF. In this case. In this case, the pump usually increases the pressure of the fluid stream FS2 by approximately 2 to 8 barg so it can be expanded to an expansion vessel which is preferably operating slightly above the pressure of the regenerator. The effect of the expansion step is usually enhanced by the temperature increase of the fluid stream FS2 when passing the crossflow heat exchanger HE-CF. The performance of an additional expansion step has the advantage that at least part of the oxygen comprised in fluid stream FS2 may be flashed-off which has a negative impact on the required purity of CO2.

The flash vessel is generally a vessel free of any particular internals. The flash vessel is preferably what is called a flash drum. Alternative flash vessels include columns having internals, for example random packings, structured packings, or trays.

In the upper region of the flash vessel, there is generally a gas draw for the gases converted to the gas phase. A demister may preferably be disposed in turn in the region of the gas draw. If required, the acid gases present may be separated from the flash gas in a further absorption column. Typically, for this purpose, a substream of the regenerated solvent is supplied to the additional absorption column.

At the base of the flash vessel, in general, the absorbent A2 at least partly laden with the acid gases that have not been converted to the gas phase is drawn off and is generally guided into regeneration step c).

### Regeneration Step c):

According to the invention, the adsorbent at least partly laden with acid gases A2 is fed into the regeneration step C), in which at least a portion of the laden absorbent A2 obtained from step b) is regenerated in a regenerator to obtain an at least partly regenerated absorbent A3 and a gaseous stream GS comprising at least one acid gas. The gaseous stream GS may comprise residual amounts of water which have not been separated off in the rescrubbing zone.

Before being introduced into the regeneration step c), the adsorbent A2 at least partly laden with acid gases is preferably guided through a crossflow heat exchanger HE-CF. In the crossflow heat exchanger HE-CF, the absorbent A2 at least partly laden with acid gases is preferably heated to a temperature in the range from 50 to 150° C., more preferably 70 to 130° C. and most preferably 80 to 110° C. In a particular embodiment, the regenerated absorbent A3 drawn from the bottom of the regenerator is used as heating medium in the heat exchanger HE-CF. This embodiment has the advantage that the thermal energy of the regenerated absorbent A3 from stage c) can be used to heat the laden absorbent A2 from step b) in heat exchanger HE-CF. In this way, it is possible to further reduce the energy costs of the overall process and to reduce the energy requirement in the reboiler of regeneration step c).

In a further preferred embodiment—as described in more detail above-, the second heat transfer material stream SHTMS3 is used as a heating medium in a heat exchanger HE-R which is in addition to or a replacement for the crossflow heat exchanger HE-CF.

### Regenerator:

According to the invention, the regeneration step is conducted in a regenerator. The regenerator is generally configured as a stripping column.

The regenerator preferably comprises a regeneration zone and a reboiler.

The regenerator is preferably operated at a top pressure in the range from 0.5 to 5 bar, preferably 0.7 to 4 and more preferably 0.9 to 2.5 bar.

In the bottom of the regenerator, there is generally disposed a liquid draw for the regenerated absorbent A3.

At the top of the regenerator, there is generally a gas draw for the gaseous stream GS. A demister is preferably mounted in the region of the gas draw.

The regenerator generally has a regeneration zone disposed above the bottom and below the rescrubbing zone. In the present context, the regeneration zone is regarded as the region of the regenerator with which the laden absorbent comes into contact with the steam which is produced in the reboiler.

To improve contact and provide a large mass transfer interface, the regeneration zone generally comprises internals, for example random packings, structured packings and/or trays, such as valve trays, bubble-cap trays, Thormann trays or sieve trays.

If the regeneration zone comprises structured packings or random packings, the height of the structured packings/random packings in the regeneration zone is preferably in the range from 5 to 15 m, more preferably in the range from 6 to 12 m and most preferably in the range from 8 to 12 m.

If the regeneration zone comprises trays, the number of trays in the regeneration zone is preferably in the range from 10 to 30, more preferably 15 to 25 and most preferably 17 to 23 trays.

In the case of columns with random packings or structured packings, the regeneration zone may in turn be divided into multiple sections, preferably 2 to 4. Bearing and holding trays and/or distributor trays may be disposed between the sections of the regeneration zone, and these improve the distribution of liquid over the entire cross section of the regenerator.

In general, the laden absorbent A2 is preferably introduced into the regenerator in the upper region or above the regeneration zone and below the rescrubbing zone. In the regeneration zone, the vapor generated in the evaporator is generally operated in countercurrent to the absorbent flowing downward through the regeneration zone.

The zone of the regenerator beneath the regeneration zone is generally referred to as the bottom.

In this region, the absorbent is typically collected and (i) fed as absorbent stream AS1 to the reboiler HE-R via pipelines via a liquid draw in the lower region of the regenerator, and/or (ii) partly recycled into the absorber as regenerated absorbent A3.

The bottom may be divided by a collecting tray disposed between the bottom draw and the feed point for the steam produced in the evaporator.

In general, at least a portion of the regenerated absorbent A3 is guided from the bottom draw of the regenerator into the reboiler as absorbent stream AS1.

Preferably, the bottom draw from the regenerator is guided completely into the reboiler as absorbent stream AS1.

The reboiler HE-R is typically a kettle type reboiler, natural circulation reboiler or themosiphon reboiler or a forced circulation reboiler.

The reboiler HE-R of the regenerator is preferably disposed outside the regenerator and connected to the bottom draw via pipelines.

The reboiler HE-R is generally operated at temperatures in the range from 100 to 150° C., preferably 105 to 140° C. and most preferably 110 to 130° C.

In the reboiler HE-R, in general, at least a portion of the bottom draw is evaporated and returned to the regenerator as absorbent stream AS2. Absorbent stream AS2 is preferably fed to the regenerator beneath the regeneration zone, preferably into the bottom of the regenerator.

If an additional collecting tray is disposed in the bottom, the steam produced in the reboiler is preferably fed in beneath the collecting tray.

### Rescrubbing Zone:

In a preferred embodiment, the regenerator has a rescrubbing zone above the regeneration zone, especially preferably above the feed point for the laden absorbent A2. The rescrubbing zone generally takes the form of a section of the regenerator disposed above the regeneration zone.

The rescrubbing zone preferably has internals, especially random packings, structured packings and/or trays to intensify the contact between the fluid stream and the scrubbing liquid. Particularly preferably, the scrubbing section has trays, especially valve trays or bubble-cap trays.

In a preferred embodiment, the internals are random packings and/or structured packings. The packing height (random packings/structured packings) is preferably within a range from 1 to 10, more preferably 2 to 8 and most preferably 3 to 6 m.

In a very particularly preferred embodiment, the rescrubbing zone has trays, especially valve trays or bubble-cap trays, the number of trays preferably being in the range from 2 to 10, more preferably 2 to 8 and most preferably 2 to 6 trays.

A scrubbing liquid may be introduced into the upper region of the rescrubbing zone or above the rescrubbing zone.

The scrubbing liquid used is generally an aqueous or slightly acidic aqueous solution, especially water. The temperature of the scrubbing liquid is generally in the range from 10 to 60° C., preferably in the range from 20 to 55° C. and more preferably 30 to 40° C.

In the rescrubbing zone, entrained residual amounts of amines may be scrubbed out of the absorbent, such that the acidic off gas GS leaving the regenerator is essentially free of amines. In the rescrubbing zone, the water content of the gas stream which is obtained at the top of the regenerator may additionally be reduced since the contact with the colder scrubbing agent can result in condensation of a portion of the vaporous water.

### Condensation Step:

In a preferred embodiment of the present invention, the acid gas stream GS from the regenerator is introduced into a condensation step.

In the condensation step, a condensate comprising water is condensed out of the gaseous stream (condensate outlet). The uncondensed gas phase is preferably discharged to a compression step, as further described below.

The condensation step is preferably conducted in such a way that the gaseous stream GS from stage c) is guided through one or more condensers (regenerator top condensers). The top condensers generally comprise a heat exchanger and a vessel in which the liquid phase can be separated from the gas phase (phase separation vessel). However, heat exchanger and vessel may also be integrated in one component. The regenerator top condenser is generally operated in such a way that water will condense, while the acid gases remain predominantly in the gas phase.

Regenerator top condensers used may, for example, be condensers having cooling coils or helical tubes, jacketed tube condensers and shell and tube heat exchangers.

The regenerator top condenser is generally operated at a temperature in the range from 10 to 60° C., preferably 20 to 55° C., more preferably 30 to 40° C.

In a preferred embodiment, the gaseous stream GS from stage c) is guided through one regenerator top condenser.

It is optionally possible to additionally introduce a scrubbing liquid, as described above, into the regenerator together with the condensate from the condensation step. The introduction can be effected via the same feed point. Scrubbing liquid can alternatively be introduced via a separate feed point.

Compression and/or Liquefaction Step:

Fluid stream GS preferably comprises CO₂.

In order to prevent release of such CO₂ to the atmosphere, the CO₂ is preferably sequestered in suitable storage locations.

Sequestration generally requires that the gaseous CO₂ stream GS is compressed and optionally cooled into a fluid which can be transported through pipelines to its destination or which can be transported as a chemical to its destination where it is utilized for further usesTypical pressures of CO₂-pressures in pipelines for transportation are 70 to 200 bar, preferably 90 to 150 bar. Typical pressures of CO₂ for transportation by ship, truck or train are 5 to 50 bar, preferably 6 to 40 and more preferably 7 to 35 bar. Compression is usually affected in one or more compressors. The compressor is usually configured to receive the CO₂ comprising gaseous stream GS and compress the gaseous stream to yield a compressed fluid stream CFS.

The compressor is typically a positive displacement compressor or a dynamic compressor. Positive displacement compressors comprise reciprocating compressors that use pistons driven by a crankshaft to deliver fluids at higher pressures. Reciprocating compressors can be single or multi-staged. Positive displacement compressors also comprise rotary screw compressors, conical screw compressors, rotary vane compressors, rolling piston compressors or scroll compressors.

The compressor can also be a dynamic compressor, such as a centrifugal compressor or an axial compressor.

Preferably, the compressor is a rotary screw compressor, a centrifugal compressor, a piston compressor or an axial flow compressor.

After compression or after each compression step in a compressor, the fluid stream CFS is preferably passed through one or more heat exchangers to dissipate the heat from the compressed fluid or to utilize the heat of compression as a heat source for heating other processes or other steps of the gas treatment process.

Alternatively, compression may be supplemented by one or more additional refrigeration steps to liquify the CO₂. CO₂ may be cooled in a heat exchanger which is an evaporator for a heat transfer material, preferably liquid ammonia. The evaporated heat transfer material is then compressed, cooled, and expanded in a tradition refrigeration circuit. It is also possible to combine two or more refrigeration circuits in series, which reduces the energy consumption of refrigeration.

Further, CO₂ may be compressed and cooled by external water and expansion to the transportation temperature and then compressed. Non-liquefied CO₂ is preferably separated a recirculated to the compression step. The energy consumption can be reduced by performing the compression and depressurization (evaporation) in several steps.

### Drying and Other Purification Steps

It is usually preferred to dry the CO₂-comprising stream GS. Drying can occur before, after or after one or more of the compression steps or cooling steps.

Drying is preferably conducted in the form of a pressure swing adsorption (PSA) and more preferably in the form of a temperature swing adsorption (TSA), or in the form of a glycol drying operation.

PSA or TSA can be conducted by methods known to the person skilled in the art. Standard variant procedures are described, for example, in Nag, Ashis, “Distillation and Hydrocarbon Processing Practices”, PennWell 2016, ISBN 978-1-59370-343-1 or in A. Terrigeol, GPA Europe, Annual Conference, Berlin, Germany, 23rd-25th May 2012 (https://www.cecachemicals.com/export/sites/ceca/.content/medias/downloads/products/dtm/molecular-sieves-contaminants-effects-consequences-and-mitigation.pdf). In PSA or TSA, preference is given to using a zeolite, activated carbon or molecular sieve.

Preference is given to using a molecular sieve as solid adsorbent in PSA or TSA.

In the glycol drying operation, preference is given to using a liquid absorbent such as monoethylene glycol (MEG), diethylene glycol (DEG), triethylene glycol (TEG) or tetraethylene glycol (TREG). TEG is especially preferably used as liquid absorbent. The glycol drying operation can be conducted by process variants known to the person skilled in the art. Examples of glycol drying are likewise found, for example, in Nag, Ashis, “Distillation and Hydrocarbon Processing Practices”, PennWell 2016, ISBN 978-1-59370-343-1.

Likewise, other components, such as carbonyl sulfide (COS) and hydrogen sulfide may be removed by installing additional filters and adsorbers.

### Transportation and Storage and Utilization:

The fluid stream CFS is preferably transported to its storage location or its final utilization. CO₂ may be transported via pipelines or by a carrier, such as truck, train, and ship.

Suited storage locations are suited geological formations, such as depleted oil and gas reservoirs, mines and saline or other rock formations.

CO₂ may also be used by the food industry, the oil industry, and the chemical industry. Preferred uses for CO₂ in the food industry is the carbonization of beverages. Other utilizations of captured carbon dioxide are enhanced oil recovery or conversion to fuel, cement, minerals, or chemicals or use as a material for fire extinguishers, as a solvent, as an inert gas or a refrigerant

### Recycling Step d):

According to the invention, the regenerated absorbent A3 obtained at the bottom of the regenerator from step c) is returned to the absorption step b).

The regenerated absorbent is preferably recycled in one of the feed points of the absorber for the regenerated absorbent as described above.

### SUMMARY

The method of the present invention allows the exploitation of the thermal energy inherent in a heat stream HS1, in particularly fluid stream FS1, to provide energy for the energy extensive regeneration step c).

The use of two heat pumps which are connected in series has the advantage that the thermal energy from heat stream HS1, in particularly FS1, can be raised to a level at where it is possible to generate steam in heat pump HP2 which can be used to transfer heat to the regeneration step c). The stream produced in heat pump HP2 can therefore effectively replace process steam usually required as a heat source in the regeneration step c). Accordingly, the use of two heat pumps in series can replace the requirement to have a separate process steam production process installed at the site of the acid gas removal unit or the requirement for steam turbines, such as back pressure turbines or pass-out condensing turbines, to produce process steam. The present invention is therefore particularly useful where process steam is not readily available at the site of an acid gas removal unit. But also, at sites where process steam is readily available, the method according to the present invention may be useful as an alternative method to produce process steam as it allows to use potentially limited process steam resources for other uses or allows to reduce power loss of power plants associated with process steam production. In addition, the method of the present invention is an interesting alternative in the design of new power plants coupled to an acid gas removal unit for carbon capture because the requirement to divert energy for steam production to power the recycling step can be reduced. In addition, the method of the present invention is a useful method to electrify steam production so that the steam required in the amine gas treating process can be provided by “green” electricity from renewable resources.

In a preferred embodiment of the invention, the thermal energy from a gaseous heat stream HS1, in particularly fluid stream FS1, is transferred to the regeneration step via an intermediate cooling loop comprising a direct contact cooler DCC and a cooling material CM. Direct heat exchange has the advantage that the exchange area between the two fluid streams HS1 and CMS1 increases, which reduces thermal resistances and maximizes the thermal efficiency. In addition, direct heat exchangers usually have lower operating and capital costs than indirect heat exchangers due to a high heat transfer rate per volume and because fouling and corrosion is usually not a problem. Additionally, expensive equipment, such as blowers or fans needed to transport the fluid streams FS1 and FS2 in an indirect gas-to-liquid heat exchanger, can be reduced or even abolished in direct heat exchangers because of the lower pressure drop in a direct heat exchanger compared to an indirect heat exchanger.

The method of the present invention is particularly efficient when:
using water as cooling medium in cooling mediums streams CMS1 and CMS2,
using ammonia or butane or R¹²³³zd(e) as heat transfer material HTM1; and
using water as heat transfer material HTM2.

When using this combination of cooling and heat transfer materials, a particular high value for the coefficient of performance of the heat pumps can be achieved.

In a preferred embodiment of the invention, the method of the present invention can be combined with additional heat pumps which are designed to transfer thermal energy from other heat sources present in the gas treating process.

Such other heat sources, include but are not limited to the heat sources HS set out above, including but not limited to:
the heat of absorption occurring in the absorber, which can be utilized in an intercooler or by the integration of heat exchangers into the absorber,
the heat of absorption in the rescrubbing zone at the top of the absorber, if the rescrubbing zone is equipped with a pump and a cooler,
the heat of condensation of condensate at the head of the absorber or the regenerator,
the heat of compression in the compression step which is created when compressing gaseous stream GS into a supercritical fluid.

Using these additional measures can help to reduce the energy requirement for carbon capture and storage even further resulting in a reduced diversion of electric power from a power plant to the gas treating unit.

### 2nd Aspect—APparatus for Producing a Deacidified Fluid Stream

In a second aspect, the invention is directed to an apparatus for deacidifying a fluid stream

FIG. 1 shows an apparatus for deacidifying a fluid stream useful for implementing a process according to embodiment A of the present invention, comprising:
a) a direct contact cooler, comprising
   a. an inlet for a fluid stream FS1;
   b. an outlet for fluid stream FS2;
   c. an inlet for a cooling medium stream CMS1; and
   d. an outlet for cooling medium stream CMS2
b) an absorber with
   a. an inlet for fluid stream FS2,
   b. an outlet for a deacidified fluid stream FS3;
   c. an inlet for an absorbent stream A1,
   d. an inlet for regenerated absorbent stream A3; and
   e. an outlet for a laden absorbent stream A2
c) a regenerator with
   a. an inlet for laden absorbent stream A2;
   b. an outlet for regenerated absorbent stream A3 and/or AS1;
   c. an inlet for absorbent stream AS2;
   d. an outlet for an acid gas stream GS;
d) a heat pump HP1, comprising
   a. a heat exchanger HE1 with
      i. an inlet for heat transfer material stream HTMS1; and
      ii. an outlet for heat transfer material stream HTMS2;
   b. one or more compressors in series, wherein the first compressor in series has an inlet for heat transfer material stream HTMS2 and the last compressor in series has an outlet for heat transfer material stream HTMS3;
   c. a heat exchanger HE-R, comprising
      i. an inlet for heat transfer material stream HTMS3;
      ii. an outlet for heat transfer material stream HTMS4;
      iii. a second inlet for an absorbent stream AS1; and
      iv. a second outlet for an absorbent stream AS2.

FIG. 2 shows an apparatus for deacidifying a fluid stream useful for the implementation of a process according to embodiment B of the present invention, additionally comprising
e) a heat pump HP2, comprising
   a. a heat exchanger HE2 with
      i. an inlet for heat transfer material stream SHTMS1,
      ii. an outlet for heat transfer material stream SHTMS2;
      iii. an inlet for heat transfer material stream HTMS3; and
      iv. an outlet for heat transfer material stream HTMS4
   b. one or more compressors in series, wherein the first compressor in series has an inlet for heat transfer material stream SHTMS2 and the last compressor in series has an outlet for heat transfer material stream SHTMS3;
   c. a heat exchanger HE-R replacing heat exchanger HE-R of claim 16, comprising
      i. an inlet for heat transfer material stream SHTMS3;
      ii. an outlet for heat transfer material stream SHTMS4;
      iii. a second inlet for an absorbent stream AS1; and
      iv. a second outlet for an absorbent stream AS2.

FIG. 3 shows an apparatus which is useful for implementing a process according to embodiment C of the present invention with direct heat transfer in step i), comprising
a) an absorber with
   a. an inlet for fluid stream FS2,
   b. an outlet for a deacidified fluid stream FS3;
   c. an inlet for an absorbent stream A1,
   d. an inlet for regenerated absorbent stream A3; and
   e. an outlet for a laden absorbent stream A2
b) a regenerator with
   a. an inlet for laden absorbent stream A2;
   b. an outlet for regenerated absorbent stream A3 and/or AS1;
   C. an inlet for absorbent stream AS2;
   d. an outlet for an acid gas stream GS;
c) a heat pump HP1, comprising
   a. a heat exchanger HE1 which is a direct contact cooler with
      i. an inlet for heat transfer material stream HTMS1; and
      ii. an outlet for heat transfer material stream HTMS2a;
   b. one or more evaporations means for expanding heat transfer material HTMS2a with.
      i. an inlet for heat transfer material stream HTMS2a; and
      ii. an outlet for heat transfer material stream HTMS2b (g);
   c. one or more compressors in series, wherein the first compressor in series has an inlet for heat transfer material stream HTMS2b (g) and the last compressor in series has an outlet for heat transfer material stream HTMS3;
   d. a heat exchanger HE-R, comprising
      i. an inlet for heat transfer material stream HTMS3;
      ii. an outlet for heat transfer material stream HTMS4;
      iii. a second inlet for an absorbent stream AS1; and
      iv. a second outlet for an absorbent stream AS2.

FIG. 4 shows an apparatus useful for the implementation of a process of the invention according embodiment C with indirect heat transfer in step i), comprising:
a) a direct contact cooler, comprising
   a. an inlet for a fluid stream FS1;
   b. an outlet for fluid stream FS2;
   c. an inlet for a cooling medium stream CMS1; and
   d. an outlet for cooling medium stream CMS2
b) an absorber with
   a. an inlet for fluid stream FS2,
   b. an outlet for a deacidified fluid stream FS3;
   c. an inlet for an absorbent stream A1,
   d. an inlet for regenerated absorbent stream A3; and
   e. an outlet for a laden absorbent stream A2
c) a regenerator with
   a. an inlet for laden absorbent stream A2;
   b. an outlet for regenerated absorbent stream A3 and/or AS1;
   c. an inlet for absorbent stream AS2;
   d. an outlet for an acid gas stream GS;
d) a heat pump HP1, comprising
   a. a heat exchanger HE1 with
      i. an inlet for heat transfer material stream HTMS1; and
      ii. an outlet for heat transfer material stream HTMS2a;
   b. one or more evaporations means for expanding heat transfer material HTMS2a with.
      i. an inlet for heat transfer material stream HTMS2a; and
      ii. an outlet for heat transfer material stream HTMS2b (g);
   c. one or more compressors in series, wherein the first compressor in series has an inlet for heat transfer material stream HTMS2b (g) and the last compressor in series has an outlet for heat transfer material stream HTMS3;
   d. a heat exchanger HE-R, comprising
      i. an inlet for heat transfer material stream HTMS3;
      ii. an outlet for heat transfer material stream HTMS4;
      iii. a second inlet for an absorbent stream AS1; and
      iv. a second outlet for an absorbent stream AS2.

In all figures, the absorber is configured as an absorption column.

The absorption column preferably has an absorption zone. In the context of the present invention, the absorption zone is deemed to be the section of an absorption column in which the fluid stream comes into mass transfer contact with the absorbent. To improve contact and provide a large mass transfer interface, the absorption zone preferably comprises internals, preferably random packings, structured packings and/or trays. In a column having random packing or structured packing, the absorption zone is preferably divided into two to four packing sections arranged one on top of another that are separated from one another by bearing and holding trays and/or a distributor tray. If the absorption zone comprises random packings or structured packings, the height of the structured packings/random packings in the absorption zone is preferably in the range from 5 to 20 m, more preferably in the range from 6 to 15 m and most preferably in the range from 8 to 14 m.

If the absorption zone comprises trays, the number of trays in the absorption zone is preferably in the range from 8 to 30, more preferably 12 to 25 and most preferably 15 to 23 trays.

Preferably below or in the lower region of the absorption zone, there is an inlet for the fluid stream FS2 to be deacidified.

Fresh absorbent A1 can be fed in via an inlet in the upper region or above the absorption zone. The supply of fresh absorbent may also include the supply of individual constituents of the absorbent, such as make-up water.

Regenerated absorbent A3 may be fed in via the same inlet or an inlet which is likewise in the upper region or above the absorption zone.

Preferably above the absorption zone, preferably at the top of the absorption column, there is an outlet for the deacidified fluid stream FS3.

A demister (not shown) is preferably mounted in the region of the draw point for the deacidified fluid stream.

In a particularly preferred embodiment, there is a feed point for scrubbing agent in the upper region or above the absorption zone (not shown).

In a very particular embodiment, the absorber comprises an additional rescrubbing zone above the absorption zone (not shown). The rescrubbing zone is generally configured as a section of the absorber in the form of a rectifying section disposed above the feed point for the absorbent. The rescrubbing zone preferably has random packings, structured packings and/or trays to intensify the contact between the fluid stream and the scrubbing liquid. The rescrubbing zone especially has trays, especially valve trays, bubble-cap trays, Thormann trays or sieve trays.

There is preferably a feed point (not shown) for scrubbing agent above the rescrubbing zone. The rescrubbing zone comprises preferably 1 to 7, more preferably 2 to 6 and most preferably 3 to 5 trays, or a packing height (random packings or structured packings) of preferably 1 to 6 m, more preferably 2 to 5 and most preferably 2 to 3 m. A collecting tray (not shown) may be disposed beneath the rescrubbing zone, on which scrubbing liquid can be collected and recycled. The recycling is generally affected here by means of a pump (not shown) that pumps the scrubbing liquid from the collecting tray to the feed point. In the case of recycling, the scrubbing liquid may be cooled by means of a heat exchanger (not shown).

There is preferably a liquid draw for the laden absorbent A2 in the lower region of the absorber.

In a preferred embodiment, there is a heat exchanger HE-CF between the liquid draw for the laden absorbent in the absorber and the feed for the laden absorbent in the regenerator. The heating medium used for this heat exchanger is preferably the recycle stream of the regenerated absorbent A3 from the bottom of the regenerator to the absorber. In this preferred embodiment, the energy demand of the overall process can be reduced.

The heat exchanger HE-CF may be configured as a plate heat exchanger or shell and tube heat exchanger. The heating medium used in the heat exchanger is preferably the bottom stream from the regenerator.

In the figures, the outlet for laden absorbent A2 from the absorber is preferably connected via a heat exchanger to the regenerator via pipelines.

The regenerator in all figures preferably comprise a regeneration zone, an evaporator, a feed inlet for the laden absorbent A2, a liquid draw (outlet) in the bottom of the regenerator for at least partially regenerates absorbent A3, a rescrubbing zone (not shown) and a outlet for the drawing of acid gas stream GS in the top region of the regenerator. In the present context, the regeneration zone is regarded as the region of the regenerator with which the laden absorbent comes into contact with the steam which is produced by the reboiler.

To improve contact and provide a large mass transfer interface, the regeneration zone preferably comprises internals, preferably random packings, structured packings and/or trays.

In a column having random packing or structured packing, the regeneration zone is preferably divided into two to four packing sections arranged one on top of another that are separated from one another by bearing and holding trays and/or a distributor tray. If the regeneration zone comprises random packings or structured packings, the height of the random packings/structured packings in the regeneration zone is preferably in the range from 5 to 15 m, more preferably in the range from 6 to 12 m and most preferably in the range from 8 to 12 m.

If the regeneration zone comprises trays, the number of trays in the regeneration zone is preferably in the range from 10 to 30, more preferably 15 to 25 and most preferably 17 to 23 trays.

The feed inlet for the laden absorbent A2 is preferably above or in the upper region of the regeneration zone.

The regenerator in FIGS. 1 and 2 additionally comprises an reboiler HE-R. The reboiler is preferably a kettle-type reboiler, a natural circulation evaporator or a forced circulation evaporator.

The reboiler HE-R is preferably connected to a liquid draw at the bottom of the regenerator via a pipeline to introduce absorbent stream AS1 to the reboiler HE-R. The bottom generally refers to the region beneath the regeneration zone.

The absorbent stream AS2, which usually is a vapor-liquid mixture generated in the reboiler, is preferably introduced into the lower region of the regenerator via a feed point above the liquid draw at the bottom but below the regeneration zone.

In a further preferred embodiment, the bottom of the regenerator is divided by a collecting tray (not shown). The absorbent collected therein is supplied to the crossflow heat exchanger HE-CF. Stream AS2 is preferably recycled to the regenerator beneath the collecting tray.

The regenerator in all figures preferably comprises a draw point for the gaseous stream GS formed in the regeneration. The draw point for the gaseous stream GS formed in the regeneration is preferably disposed in the top region of the regenerator. There is preferably a demister (not shown) in the region of the draw point.

The regenerator in the figures preferably comprises a rescrubbing zone (not show) having internals. The internals present in the rescrubbing zone are preferably structured packings or random packings, where the packing height (random packings/structured packings) is preferably in the range from 1 to 10 m, more preferably 2 to 8 and most preferably in the range from 3 to 6 m. Alternatively, the internals present in the rescrubbing zone are trays. More particularly, the number of trays is preferably in the range of 3 to 20, more preferably 4 to 16 and is preferably 6 to 12. The trays in the scrubbing section may for example be valve trays, bubble-cap trays, Thormann trays or sieve trays.

In the figures, there may be a separate feed for scrubbing liquid above or in the upper region of the rescrubbing zone (not shown). If scrubbing liquid, such as freshwater, is additionally supplied, it is preferable to guide this scrubbing liquid into the regenerator together with the condensate from an additional condensation step at the top of the regenerator. Preferably, the draw point for the gaseous stream GS formed in the regenerator is connected to a top condenser (not shown). The top condenser preferably comprises a heat exchanger, a vessel for phase separation (phase separation vessel), a gas draw and a condensate outlet. Condensers used may, for example, be condensers having cooling coils or helical tubes, jacketed tube condensers and shell and tube heat exchangers.

The invention is illustrated by the following examples:

Example 1 is based on calculations performed using a simulation model. The phase equilibria for the carbon capture part were described using a model by Pitzer (K. S. Pitzer, Activity Coefficients in Electrolyte Solutions 2nd ed., CRC Press, 1991, Chapter 3, Ion Interaction Approach: Theory). The simulation of the absorption processes is described by means of a mass transfer-based approach; details of this are given in Asprion (Asprion, N.: Nonequilibrium Rate-Based Simulation of Reactive Systems: Simulation Model, Heat Transfer, and Influence of Film Discretization, Ind. Eng. Chem. Res. (2006) 45 (6), 2054-2069).

For the heat pumps the required thermodynamic data are provided by PC-SAFT (NH3), (Gross, J.; Sadowksi, G.: Industrial & engineering chemistry research, 2002, 41 (22) 5510) and for water by NBS tables (NBS/NCR Steam Tables by L. Haar, et al., New York: Hemisphere Publishing, 1984), respectively.

Example 2 is based on calculations using a further simulation tool called EBSILON® Professional (www.ebsilon.com) using the thermodynamic package REFPROP (https://refprop-docs.readthedocs.io/en/latest/DLL/index.html) The tool is typically applied for the simulation of power plants, but also in general for any type of a thermodynamic cycle.

### Example 1: Use of Cooling Medium Stream CMS2 from a Direct Contact Cooler (DCC) as Heat Stream HS1 for a Serial Heat Pump

Example 1 is based on the process scheme represented in FIG. 2 comprising the combination of a direct contact cooler and two serially connercted heat pumps HP1 and HP2, in which heat pump HP2 is configured as an open-loop heat pump, with some variations as further described below:

A fluid stream FS1 of 1389 t/h having the composition depicted in Table A below and a temperature of 70° C. and a pressure of 1.01 bar is fed to the bottom of a heat exchanger HE-C which is configured as a direct contact cooler (DCC). In HE-C, FS1 is contacted in countercurrent flow with water as cooling medium stream CMS1 to obtain a fluid stream FS2 with a flow rate of 124.1 t/h at a temperature of 35° C. and a pressure of 0.99 bar, which is slightly compressed to a pressure of 1.07 bar and a temperature of 43.4° C. before being introduced to the absorption step b). CMS1 is introduced at the top of the HE-C with a flow rate of 3233.3 t/h at a temperature of 40° C. and a pressure of 2.25 bar. Thermal energy is transferred from fluid stream FS1 to cooling medium stream CMS1 to obtain a cooling medium stream CMS2 at the bottom of HE-C. A small part of CMS2 (150.7 t/h) is purged from the process. 3275 t/h of CMS2 having a temperature of 61.4° C. and a pressure of 1.01 bar are used as a heat stream HS1 for a serial heat pump comprising a first heat pump HP1 with ammonia as heat transfer material HTM1 and a second heat pump HP2 with water as heat transfer material HTM2. Heat pump HP1 is designed as a closed-loop heat pump including a regeneration step. Heat pump HP2 is designed as an open-loop heat pump. Thermal energy from heat stream HS1 (CMS2) is transferred through evaporator HE1 of heat pump HP1 to a heat transfer material stream HTMS1 having a flow rate of 408.19 t/h at a temperature of 37.7° C. and a pressure of 14.54 bar to obtain a gaseous heat transfer material stream HTMS2 having a flow rate of 408.19 t/h and a temperature of 37.6° C. and a pressure of 14.49 bar. Further a cooled cooling medium stream CMS3 is obtained which is further cooled in an additional cooler to a temperature of 32° C. and pumped with a pressure of 4.5 bar to heat exchanger HE-C. Heat transfer material stream HTMS2 is compressed in a compressor obtain a heat transfer material stream HTMS3 at a pressure of 75.48 bar and a temperature of 197.6° C. Heat transfer material stream HTMS3 is fed to a heat exchanger HE2, which is the condenser for heat pump HP1 and the evaporator for heat pump HP2 to obtain a cooled, liquid heat transfer material stream HTMS4 having a temperature of 109.6° C. and a pressure of 75.43 bar. To close the loop and to recycle heat transfer material stream HTMS4 to heat exchanger HE1, heat transfer material stream HTMS4 is expanded to obtain a cooled heat transfer material stream HTMS5 having a temperature of 37.7° C. at a pressure of 14.54 bar, which is partially liquid (246,8 t/h) and gaseous (161.4 t/h) and which is recycled has heat transfer material stream HTMS1 to heat exchanger HE1. In heat exchanger HE2, thermal energy is transferred from heat transfer material stream HTMS3 to a second heat transfer material stream SHTMS1 having a flow rate of 174.3 t/h, a temperature of 99.6° C. at a pressure of 5 bar to obtain a second heat transfer material stream SHTMS2 having a flow rate of 174.3 t/h at a pressure of 1 bar and a temperature of 99.6° C. The second heat transfer material stream SHTMS2 is compressed in three stages, each stage comprising one compressor. In the first compressor, the pressure is increased to 1.5 bar and the temperature is increased to 146.1° C. After the first compressor a stream of additional water at a flow rate of 3.8 t/h and a temperature of 99.6° C. and a pressure of 5 bar is added to obtain a second heat transfer material stream SHTSM3* having a temperature of 121.4° C. at a pressure of 1.5 bar at a flow rate of 178.1 t/h. In the second compressor, the second heat transfer material stream STMS3* is further compressed to a pressure of 2.3 bar and a temperature of 134.1° C. Another stream of water having a temperature of 99.6° C. and a pressure of 5 bar is added at a flow rate 5.8 t/h to obtain a second heat transfer material stream SHTM3** having a temperature of 134.1° C. and a pressure of 2.3 bar at a flow rate of 183.9 t/h. In a third compressor, the second heat transfer material stream SHTMS** is still further compressed to obtain a second heat transfer material stream SHTMS*** with a pressure of 3.4 bar and a temperature of 184.3° C. Still a further stream of water having a temperature of 99.6° C., a pressure of 5 bar and flow rate of 6.1 t/h is added to second heat transfer material stream SHTMS*** to obtain second heat transfer material stream SHTMS3 having a temperature of 147.8° C. and a pressure of 3.4 bar and a flow rate of 190.0 t/h. Thermal energy from second heat transfer material stream SHTMS3 is transferred to the reboiler of an absorber to maintain a temperature of 127.3° C. at the bottom of the absorber. A cooler second heat transfer material stream SHTMS4 is obtained having a temperature of 137.3° C. and a pressure of 3.34 bar.

The coefficient of performance (COP) as a measure for the performance of the heat pump system is 2.34.

Heat pump HP2 is operated as an open-loop heat pump, i.e., the second heat transfer material stream SHTMS4 was not recycled to heat exchanger HE2. Alternatively, it would be possible to operate heat pump HP2 as a closed-loop heat pump and to recycle at least a part of the second heat transfer material stream SHTMS4 e.g., as stream SHTMS1 to the heat exchanger HE2 or to the compression step as additional streams of heat transfer material HTM2, eventually after adjusting the pressure and temperature by additional expansion, cooling or compression steps to adjust the properties of the stream HTMS4 to the respective input streams.

The example shows that the energy comprised in low temperature fluid stream FS1 can be effectively utilized to heat the regeneration step c).

To achieve this in a conventional heat pump, a heat transfer material would need to be found which would undergo a phase transition at the temperature and pressure of heat exchanger HE1 and which could be compressed to obtain the high temperatures required in regeneration step c), in particularly the reboiler. Ammonia is not suitable as it would need to be compressed to pressures where it becomes supercritical in heat exchanger HE2.

In Example 1, only that amount of steam is produced which is required in regeneration step c). Since the process of the invention produces steam, it can be supplemented by other steam sources, or it is possible to provide excess steam to other consumers. Alternatively, excess steam can be disseminated to the environment.

TABLE 1
Composition of Fluid Stream FS1

| Component | Vol.-% |
|---|---|
| H₂O | 20.9 |
| CO₂ | 7.7 |
| N₂ | 68.2 |
| O₂ | 2.4 |
| Ar | 0.9 |

### Example 2

Example 2 is based on the process scheme depicted in FIG. 4 comprising a combination of a direct contact cooler and a modified heat pump with some variations which are described below.

After transfer of heat from a fluid gas stream FS2 to a cooling medium stream CMS1 in a direct contact cooler (DCC or HE-C), a cooling medium stream CMS2 with a flow rate of 5500 t/h having a pressure of 1.2 bar and a temperature of 62° C. were obtained. Cooling medium stream CMS2 is fed to heat exchanger HE1 of modified heat pump HP1 to obtain a cooled cooling medium stream CMS3 with a temperature of 50° C. and a pressure of 1.2 bar. Stream CMS3 was additionally cooled in a water cooler to obtain a cooling medium stream CMS4 having a temperature of 42° C. which is recycled to the direct contact cooler as cooling medium stream CMS1. In heat exchanger HE1, heat is transferred from cooling medium stream CMS1 to heat transfer material stream HTMS1 having a flow rate of 5500 t/h, a pressure of 1.2 bar and a temperature of 46° C., to obtain a heat transfer material stream HTMS2 with a temperature 57° C. and a pressure of 1.15 bar. Heat transfer material streams HTMS1 and HTMS2a are streams of heat transfer material HTM1, which is water. Heat transfer material stream HTMS2a is expanded at a pressure of 0.1 bar to obtain a heat transfer material stream HTMS2b having a temperature of 46° C. and a pressure of 0.1 bar. Heat transfer material stream HTMS2b consists of a liquid stream HTMS2a (I) having a flow rate of 5500 t/h and a gaseous stream HTMS2a (g) having a flow rate of 113.6 t/h. The liquid heat transfer material stream HTMS2b (I) is recycled to heat exchanger HE1 as heat transfer material stream HTMS1 after a compression to a pressure of 1.2 bar to yield a heat transfer material stream having a flow rate of 5500 t/h at a pressure of 1.2 bar and 0 a temperature of 45.8° C. The gaseous heat transfer material stream HTMS2b (g) is fed to a compression step. Prior to expansion, an additional stream of heat transfer material HTM1 is added to heat transfer material stream HTMS2a at a flow rate of 1.15 bar and a temperature of 75° C. and a flow rate of 113.6 t/h to compensate for the gaseous part of heat transfer material stream HTMS2b being fed to the compression step and to maintain the mass balance for the recycling loop involving liquid streams HTMS1 and HTMS2a. The compression step to obtain a heat transfer material stream HTMS3 involves five compression stages, each stage comprising a compressor.

As previously described, the gaseous part of heat transfer material stream HTMS2b with a flow rate of 113.6 t/h and a temperature of45.8° C. and a pressure of 0.1 bar is fed to a first compression stage to obtain a heat transfer material stream HTMS3* with a pressure of 0.2 bar and a temperature of 114.61° C. Prior to feeding the stream HTMS3* to the second compression stage, an additional stream of heat transfer material HTM1 with a temperature of 75° C. and a pressure of 5 bar is added to stream HTMS3* at a flow rate of 3.7 t/h to obtain a heat transfer material stream HTMS3* having a pressure of 0.2 bar and a temperature of 75° C. at a flow rate of 117.3 t/h.

Heat transfer material stream HTMS3* is fed to the second compression stage to obtain a heat transfer material stream HTMS3** with a pressure of 0.4 bar and a temperature of 149.6° C. Prior to feeding the stream HTMS3** to the third compression stage, an additional stream of heat transfer material HTM1 with a temperature of 75° C. and a pressure of 5 bar is added to stream HTMS3** at a flow rate of 6.3 t/h to obtain a heat transfer material stream HTMS3** having a pressure of 0.4 bar and a temperature of 85° C. at a flow rate of 123.62 t/h.

Heat transfer material stream HTMS3** is fed to the third compression stage to obtain a heat transfer material stream HTMS3*** with a pressure of 0.8 bar and a temperature of 161.1° C. Prior to feeding the stream HTMS3*** to the fourth compression stage, an additional stream of heat transfer material HTM1 with a temperature of 75° C. and a pressure of 5 bar is added to stream HTMS3** at a flow rate of 6.0 t/h to obtain a heat transfer material stream HTMS3*** having a pressure of 0.8 bar and a temperature of 103° C. at a flow rate of 129.6 t/h.

Heat transfer material stream HTMS3*** is fed to the fourth compression stage to obtain a heat transfer material stream HTMS3**** with a pressure of 1.6 bar and a temperature of 182.1° C. Prior to feeding the stream HTMS3**** to the fifth and final compression stage, an additional stream of heat transfer material HTM1 with a temperature of 75° C. and a pressure of 5 bar is added to stream HTMS3** at a flow rate of 6.5 t/h to obtain a heat transfer material stream HTMS3**** having a pressure of 1.6 bar and a temperature of 123° C. at a flow rate of 136.1 t/h.

Heat transfer material stream HTMS3**** is fed to the fifth compression stage to obtain a heat transfer material stream HTMS3 with a pressure of 3.2 bar and a temperature of 205.2° C. Prior to feeding the stream HTMS3 to the heat exchanger HE-R to transfer heat to the regeneration step c), an additional stream of heat transfer material HTM1 with a temperature of 75° C. and a pressure of 5 bar is added to stream HTMS3 at a flow rate of 7.4 t/h to obtain a heat transfer material stream HTMS3 having a pressure of 3.2 bar and a temperature of 143° C. at a flow rate of 143.5 t/h.

Heat is transferred from heat transfer material stream HTMS3 to the regeneration step c) in the reboiler of the regenerator to maintain a temperature of 127° C. in the bottoms of the regenerator.

The coefficient of performance of the heat pump is 3.57.

The heat pump is operated as an open-loop heat pump without recycling of the heat transfer material water to the evaporation step. However, at least a part of the heat transfer material stream HTMS4 can be recycled, e.g., to the evaporation step or to the compression step, eventually after adjusting the pressure and temperature by additional expansion, cooling, or compression steps to adjust the properties of the stream HTMS4 to the respective input streams, such as heat transfer material stream HTMS1 or HTMS2a.

1.-15. (canceled)

16. A method for producing a deacidified fluid stream from a fluid stream comprising at least one acid gas, comprising:
a) transferring thermal energy from a fluid stream FS1 comprising at least one acid gas to the regeneration step c) to obtain a fluid stream FS2 having a reduced thermal energy compared to fluid stream FS1;
b) contacting a cooled fluid stream FS2 with an absorbent A1 in an absorber to obtain an absorbent A2 laden with acid gases and an at least partly deacidified fluid stream;
c) regenerating at least a portion of the laden absorbent A2 obtained from step b) in a regenerator to obtain an at least partly regenerated absorbent A3 and a gaseous stream GS comprising least one acid gas; and
d) recycling at least a substream of the regenerated absorbent A3 from step c) into the absorption step b);
wherein a thermal energy transfer step a) comprises the combination of a direct contact cooler DCC and one or more heat pumps.

17. The method according to claim 16, wherein the thermal energy transfer step a) comprises:
(i) transferring thermal energy from a fluid stream FS1 to a cooling material stream CMS1 in a direct contact cooler, to obtain a cooling material stream CMS2 and a fluid stream FS2 having a reduced thermal energy compared to fluid stream FS1;
(ii) transferring thermal energy from cooling material stream CMS2 to heat transfer material stream HTMS1 in a heat exchanger HE1 to obtain a heat transfer material stream HTMS2 having a higher thermal energy than heat transfer material stream HTMS1;
(iii) compressing the heat transfer material stream HTMS2 in one or more compression steps to obtain a heat transfer material stream HTMS3 having a higher pressure than heat transfer material stream HTMS2; and
(iv) transferring thermal energy from heat transfer material stream HTMS3 to the regeneration step c) to obtain a heat transfer material stream HTMS4.

18. The method according to claim 16, wherein the thermal energy transfer step a) comprises:
(i) transferring thermal energy from a fluid stream FS1 to a liquid heat transfer material stream HTMS1 of a heat transfer material HTM1 in a direct contact cooler to obtain a liquid heat transfer material stream HTMS2a;
(ii) expanding the heat transfer medium stream HTMS2a in one or more expansion steps to obtain a gaseous heat transfer material stream HTMS2b (g) having a lower pressure than heat transfer material stream HTMS2a;
(iii) compressing the heat transfer material stream HTMS2b (g) in one or more compression steps to obtain a gaseous heat transfer material stream HTMS3 having a higher pressure than heat transfer material stream HTMS2b (g); and
(iv) transferring thermal energy from heat transfer material stream HTMS3 to the regeneration step c) to obtain a heat transfer material stream HTMS4.

19. The method according to claim 17, further comprising an additional recycling step R¹) in which the heat transfer material stream HTMS4 obtained in step iv) is recycled to step i) or step (ii).

20. The method according to claim 17, wherein heat transfer material stream HTMS4 is not recycled to heat exchanger HE1.

21. The method according to claim 16, wherein the thermal energy transfer steps comprises:
i) transferring thermal energy from heat stream HS1 in a heat exchanger HE1 of the first heat pump HP1 to a heat transfer medium stream HTMS1 of a heat transfer material HTM1 to obtain a heat transfer medium stream HTMS2 having an increased thermal energy compared to heat transfer medium stream HTMS1;
ii) compressing heat transfer medium stream HTMS2 in the first heat pump HP1 to obtain a heat transfer medium stream HTMS3 having a higher pressure than heat transfer medium stream HTMS2;
iii) transferring thermal energy from heat transfer medium stream HTMS3 of the first heat pump HP1 in a heat exchanger HE2 of the second heat pump HP2 to a second heat transfer medium stream SHTMS1 of a second heat transfer material HTM2 to obtain a second heat transfer medium stream SHTMS2 having an increased thermal energy compared to the second heat transfer medium stream SHTMS1 and a heat transfer medium stream HTMS4 having a reduced thermal energy content compared to heat transfer medium stream HTMS3;
iv) compressing the second heat transfer medium stream SHTMS2 in the second heat pump HP2 to obtain a second heat transfer medium stream SHTMS3 having a higher pressure than the second heat transfer medium stream SHTMS2; and
V transferring thermal energy from the second heat transfer medium stream SHTMS3 of the second heat pump HP2 to the regeneration step c) to obtain a second heat transfer medium stream SHTMS4 having a reduced thermal energy content compared to SHTMS3.

22. The method according to claim 17, wherein step iv) is carried out by transferring thermal energy from the second heat transfer medium stream SHTMS4 to an absorbent stream AS1 withdrawn from the regenerator in step c) in a heat exchanger HE-R to obtain an absorbent stream AS2 having an increased thermal energy compared to absorbent stream AS1 and feeding AS2 to the regenerator in step c).

23. The method according to claim 21, wherein step v) is carried out by transferring thermal energy from the second heat transfer medium stream SHTMS4 to an absorbent stream AS1 withdrawn from the regenerator in step c) in a heat exchanger HE-R to obtain an absorbent stream AS2 having an increased thermal energy compared to absorbent stream AS1 and feeding AS2 to the regenerator in step c).

24. The method according to claim 22, wherein the heat exchanger HE-R is the reboiler of the regenerator.

25. The method according to one of claim 21, further comprising:
an additional recycling step R¹) in which the heat transfer material stream HTMS4 obtained in step 3) is expanded to obtain a heat transfer medium stream HTMS5 having a reduced pressure compared to heat transfer material stream HTMS4 and which is at least partially recycled to step 1) as heat transfer material stream HTMS1, or
an additional recycling step R²) in which the second heat transfer material stream SHTMS4 obtained in step 5) is expanded to obtain a second heat transfer medium stream SHTMS5 having a reduced pressure compared to the second heat transfer material stream SHTMS4 and which is at least partially recycled to step 3) as the second heat transfer material stream SHTMS1, or a method according to claim 21 wherein the second heat transfer material stream SHTMS4 is not recycled to heat exchanger HE2.

26. The method according to claim 21 wherein heat transfer material HTM1 is selected from the group consisting of ammonia, butane and RZ123zd(e) and wherein the second heat transfer material HTM2 is water.

27. The method according to claim 17, wherein heat transfer material streams HTMS 1 to 4 are streams of heat transfer material HTM1 and wherein heat transfer material HTM1 is selected from the group consisting of ammonia, butane, R1233zd(e), R1224yd(z), air, CO₂, water, chlorofluorocarbon, hydrochlorofluorocarbon, hydrofluorocarbon, hydrofluoroolefin, hydrochlorofluoroolefin, hydrocarbon, perfluoro (2-methyl-3-pentanone) and mixtures of two or more thereof.

28. An apparatus comprising:
a) a direct contact cooler, comprising
a. an inlet for a fluid stream FS1;
b. an outlet for fluid stream FS2;
c. an inlet for a cooling medium stream CMS1; and
d. an outlet for cooling medium stream CMS2
b) an absorber with
a. an inlet for fluid stream FS2,
b. an outlet for a deacidified fluid stream FS3;
c. an inlet for an absorbent stream A1,
d. an inlet for regenerated absorbent stream A3; and
e. an outlet for a laden absorbent stream A2
c) a regenerator with
a. an inlet for laden absorbent stream A2;
b. an outlet for regenerated absorbent stream A3 and/or AS1;
c. an inlet for absorbent stream AS2;
d. an outlet for an acid gas stream GS;
d) a heat pump HP1, comprising
a. a heat exchanger HE1 with
i. an inlet for heat transfer material stream HTMS1; and
ii. an outlet for heat transfer material stream HTMS2;
b. one or more compressors in series, wherein the first compressor in series has an inlet for heat transfer material stream HTMS2 and the last compressor in series has an outlet for heat transfer material stream HTMS3;
c. a heat exchanger HE-R, comprising
i. an inlet for heat transfer material stream HTMS3;
ii. an outlet for heat transfer material stream HTMS4;
iii. a second inlet for an absorbent stream AS1; and
iv. a second outlet for an absorbent stream AS2.

29. The apparatus according to claim 28, additionally comprising
e) a heat pump HP2, comprising
a. a heat exchanger HE2 with
i. an inlet for heat transfer material stream SHTMS1,
ii. an outlet for heat transfer material stream SHTMS2;
iii. an inlet for heat transfer material stream HTMS3; and
iv. an outlet for heat transfer material stream HTMS4
b. one or more compressors in series, wherein the first compressor in series has an inlet for heat transfer material stream SHTMS2 and the last compressor in series has an outlet for heat transfer material stream SHTMS3;
c. a heat exchanger HE-R replacing heat exchanger HE-R of claim 26, comprising
i. an inlet for heat transfer material stream SHTMS3;
ii. an outlet for heat transfer material stream SHTMS4;
iii. a second inlet for an absorbent stream AS1; and
iv. a second outlet for an absorbent stream AS2.

30. An apparatus comprising:
a) an absorber with
a. an inlet for fluid stream FS2,
b. an outlet for a deacidified fluid stream FS3;
c. an inlet for an absorbent stream A1,
d. an inlet for regenerated absorbent stream A3; and
e. an outlet for a laden absorbent stream A2
b) a regenerator with
a. an inlet for laden absorbent stream A2;
b. an outlet for regenerated absorbent stream A3 and/or AS1;
c. an inlet for absorbent stream AS2;
d. an outlet for an acid gas stream GS;
c) a heat pump HP1, comprising
a. a heat exchanger HE1 which is a direct contact cooler with
i. an inlet for heat transfer material stream HTMS1; and
ii. an outlet for heat transfer material stream HTMS2a;
b. one or more evaporations means for expanding heat transfer material HTMS2a with.
i. an inlet for heat transfer material stream HTMS2a; and
ii. an outlet for heat transfer material stream HTMS2b;
c. one or more compressors in series, wherein the first compressor in series has an inlet for heat transfer material stream HTMS2b and the last compressor in series has an outlet for heat transfer material stream HTMS3;
d. a heat exchanger HE-R, comprising
i. an inlet for heat transfer material stream HTMS3;
ii. an outlet for heat transfer material stream HTMS4;
iii. a second inlet for an absorbent stream AS1; and
iv. a second outlet for an absorbent stream AS2; or
an apparatus comprising:
a) a direct contact cooler, comprising
a. an inlet for a fluid stream FS1;
b. an outlet for fluid stream FS2;
c. an inlet for a cooling medium stream CMS1; and
d. an outlet for cooling medium stream CMS2
b) an absorber with
a. an inlet for fluid stream FS2,
b. an outlet for a deacidified fluid stream FS3;
c. an inlet for an absorbent stream A1,
d. an inlet for regenerated absorbent stream A3; and
e. an outlet for a laden absorbent stream A2
c) a regenerator with
a. an inlet for laden absorbent stream A2;
b. an outlet for regenerated absorbent stream A3 and/or AS1;
c. an inlet for absorbent stream AS2;
d. an outlet for an acid gas stream GS;
d) a heat pump HP1, comprising
a. a heat exchanger HE1 with
i. an inlet for heat transfer material stream HTMS1; and
ii. an outlet for heat transfer material stream HTMS2a;
b. one or more evaporations means for expanding heat transfer material HTMS2a with.
i. an inlet for heat transfer material stream HTMS2a; and
ii. an outlet for heat transfer material stream HTMS2b;
c. one or more compressors in series, wherein the first compressor in series has an inlet for heat transfer material stream HTMS2b and the last compressor in series has an outlet for heat transfer material stream HTMS3;
d. a heat exchanger HE-R, comprising
i. an inlet for heat transfer material stream HTMS3;
ii. an outlet for heat transfer material stream HTMS4;
iii. a second inlet for an absorbent stream AS1; and
iv. a second outlet for an absorbent stream AS2.

31. The method according to claim 16, wherein the fluid stream comprising at least one acid gas is a flue gas comprising CO₂ and wherein the absorbent comprises at least one amine and water.
